(19) United States
(12) Patent Application Publication
(10) Pub. No.: US 2026/0024175 A1
(43) Pub. Date: Jan. 22, 2026

(54) SYSTEMS AND METHODS FOR IMAGE PROCESSING

(71) Applicant: PEKING UNIVERSITY, Beijing (CN)

(72) Inventors: Liangyi CHEN, Beijing (CN); Xiaoshuai HUANG, Beijing (CN); Junchao FAN, Chongqing (CN); Jianyong WANG, Beijing (CN); Bo ZHOU, Beijing (CN)

(73) Assignee: PEKING UNIVERSITY, Beijing (CN)

(21) Appl. No.: 19/305,756

(22) Filed: Aug. 20, 2025

Related U.S. Application Data
(63) Continuation of application No. PCT/CN2024/077786, filed on Feb. 20, 2024.
Application No. PCT/CN2024/077786 is a continuation-in-part of application No. 18/171,394, filed on Feb. 20, 2023.

(30) Foreign Application Priority Data
Jan. 31, 2024 (CN) 202410138010.5

(51) Int. Cl. G06T 5/60; G06T 5/70

(52) U.S. Cl. CPC G06T 5/60; G06T 5/70; G06T 2207/10056; G06T 2207/10064; G06T 2207/20081; G06T 2207/20084

(57) ABSTRACT

Methods and systems for image processing are provided. The method may include obtaining image data generated by an image acquisition device; generating a preliminary image by processing the image data; and generating a target image by using an image processing model to process the preliminary image according to an optimization algorithm. The image processing model includes a first sub-model and a second sub-model. The first sub-model is configured to determine a first optimization term related to a likelihood term of an objective function, and the second sub-model is configured to determine a second optimization term related to a regularization term of the objective function, wherein the second sub-model is a trained machine-learning model.

### CROSS-REFERENCE TO RELATED APPLICATIONS

This application is a continuation of International patent application No. PCT/CN2024/077786, filed on Feb. 20, 2024, which claims priority to U.S. patent application Ser. No. 18/171,394, filed on Feb. 20, 2023, and Chinese Patent Application No. 202410138010.5, filed on Jan. 31, 2024, the contents of each of which are hereby incorporated by reference.

### TECHNICAL FIELD

The present disclosure relates to the field of image processing, and in particular, to systems and methods for reconstructing an image based on image data generated by an image acquisition device.

### BACKGROUND

Super-resolution microscopy is a series of techniques in optical microscopy that allow images to have resolutions higher than those imposed by the diffraction limit. The emergence of super-resolution (SR) fluorescence microscopy technologies may have revolutionized biology and enabled previously unappreciated and intricate structures to be observed, such as periodic actin rings in neuronal dendrites, nuclear pore complex structures, and the organization of pericentriolar materials surrounding the centrioles. Since super-resolution microscopic images are expected to show a clear and accurate view of microstructures, requirements for the image quality of the SR microscopic images are usually high. Many conventional techniques for reconstructing super-resolution microscopic images suffer from artifacts. Moreover, sometimes even errors may occur in the reconstructed image. Therefore, it is desirable to provide systems and methods for reconstructing images with improved quality.

Fluorescence microscopy (FM) is crucial for expounding the dynamics and functions of various biological processes in living cells. However, FMs may suffer drawbacks and tradeoffs because they partition a finite signal spatiotemporal budget. These limitations may manifest when comparing different microscope types (e.g., three-dimensional structured illumination microscopy (3D-SIM) offers better spatial resolution than high-numerical-aperture Fourier light field microscopy (FLFM) but lower speed); different implementations of the same microscope type (e.g., 3D-SIM offer better spatial resolution than 3D confocal spinning disk microscopy (3D-CSDM) but worse photobleaching); and, within the same microscope, shorter exposures and smaller pixels can increase speed and resolutions at the expense of signal-to-noise (SNR) due to the imaging noise related to the camera. Performance tradeoffs may be especially severe when considering live-cell super-resolution microscopy applications, in which the desired spatiotemporal resolution must be balanced against SNR.

In addition to advances in microscope hardware, computational approaches have become increasingly important for image restoration in FM. The statistical viewpoint of FM image restoration accounts for loss of information and measurement uncertainties in the observations of the sample by the camera. And the image restoration process can be transformed into a linear inverse problem consisting of a fidelity term corresponding to the camera observation process and a regularization term corresponding to the sample prior distribution. Designing an appropriate regularization term that can capture the complex statistics of the sample may be essential. Various mathematically handcrafted regularization terms are developed, while the complexity of the sample is only partially reflected in their formulation. Thus, handcrafted analytical models are limited by the accuracy of their assumptions, potentially resulting in quality losses of restored images. Deep learning (DL) can provide strong expressiveness and can approximate the complex sample distribution with infinitesimal errors theoretically. A proper statistical modeling of regularization term may be determined based on DL.

In the present disclosure, restoration methods are provided for microscopy (e.g., SIM, CSDM, wide field microscopy (WFM), FLFM, etc.). The restoration can interpretably combine the camera imaging noise model based fidelity term with the DL based regularization term and provide noise-free, artifacts-free, high-fidelity, high-contrast restorations.

### SUMMARY

According to an aspect of the present disclosure, a method for image processing is provided. The method is implemented on a machine having at least one processor and at least one storage device. The method may include obtaining image data generated by an image acquisition device; generating a preliminary image by processing the image data; generating a target image by using an image processing model to process the preliminary image according to an optimization algorithm, the image processing model including a first sub-model and a second sub-model. The first sub-model may be configured to determine a first optimization term related to a likelihood term of an objective function. The second sub-model may be configured to determine a second optimization term related to a regularization term of the objective function, wherein the second sub-model is a trained machine-learning model.

According to another aspect of the present disclosure, a system for image processing is provided. The system may include at least one storage device including a set of instructions; and at least one processor in communication with the at least one storage device, wherein when executing the set of instructions, the at least one processor is directed to cause the system to perform operations including: obtaining image data generated by an image acquisition device; generating a preliminary image by processing the image data; generating a target image by using an image processing model to process the preliminary image according to an optimization algorithm, the image processing model including a first sub-model and a second sub-model, wherein the first sub-model is configured to determine a first optimization term related to a likelihood term of an objective function, and the second sub-model is configured to determine a second optimization term related to a regularization term of the objective function, wherein the second sub-model is a trained machine-learning model.

According to another aspect of the present disclosure, a system for image processing is provided. The system may include: an obtaining module configured to obtain image data generated by an image acquisition device; a preliminary image generation module configured to generate a preliminary image by processing the image data; a target image generation module configured to generate a target image by using an image processing model to process the preliminary image according to an optimization algorithm. The image processing model may include a first sub-model and a second sub-model. The first sub-model may be configured to determine a first optimization term related to a likelihood term of an objective function. The second sub-model may be configured to determine a second optimization term related to a regularization term of the objective function, wherein the second sub-model is a trained machine-learning model.

According to another aspect of the present disclosure, a non-transitory computer readable medium, comprising at least one set of instructions for image processing, wherein when executed by one or more processors of a computing device, the at least one set of instructions causes the computing device to perform a method. The method may include obtaining image data generated by an image acquisition device; generating a preliminary image by processing the image data; generating a target image by using an image processing model to process the preliminary image according to an optimization algorithm, the image processing model including a first sub-model and a second sub-model. The first sub-model may be configured to determine a first optimization term related to a likelihood term of an objective function. The second sub-model may be configured to determine a second optimization term related to a regularization term of the objective function, wherein the second sub-model is a trained machine-learning model.

According to an aspect of the present disclosure, a method for image processing is provided. The method is implemented on a machine having at least one processor and at least one storage device. The method may include: obtaining multi-dimensional image data, wherein the multi-dimensional image data is generated by a fluorescence microscopy; generating an initial multi-dimensional image based on the multi-dimensional image data; and constructing an objective function based on an acquisition process of the multi-dimensional image data, and generating a target image by performing one or more iterations on the initial multi-dimensional image according to the objective function. The objective function may include a fidelity term and a regularization term. The fidelity term may be related to an imaging physical model of the fluorescence microscopy. The regularization term may be determined using a regularization network.

According to another aspect of the present disclosure, a system for image processing is provided. The system may include at least one storage device including a set of instructions; and at least one processor in communication with the at least one storage device, wherein when executing the set of instructions, the at least one processor is directed to cause the system to perform operations including: obtaining multi-dimensional image data, wherein the multi-dimensional image data is generated by a fluorescence microscopy; generating an initial multi-dimensional image based on the multi-dimensional image data; and constructing an objective function based on an acquisition process of the multi-dimensional image data, and generating a target image by performing one or more iterations on the initial multi-dimensional image according to the objective function. The objective function may include a fidelity term and a regularization term. The fidelity term may be related to an imaging physical model of the fluorescence microscopy. The regularization term may be determined using a regularization network.

According to another aspect of the present disclosure, a system for image processing is provided. The system may include: an image data obtaining module configured to obtain multi-dimensional image data, wherein the multi-dimensional image data is generated by a fluorescence microscopy; an initial image generation module configured to generate an initial multi-dimensional image based on the multi-dimensional image data; and a target image generation module configured to construct an objective function based on an acquisition process of the multi-dimensional image data, and generate a target image by performing one or more iterations on the initial multi-dimensional image according to the objective function. The objective function may include a fidelity term and a regularization term. The fidelity term may be related to an imaging physical model of the fluorescence microscopy. The regularization term may be determined using a regularization network.

According to another aspect of the present disclosure, a non-transitory computer readable medium, comprising at least one set of instructions for image processing, wherein when executed by one or more processors of a computing device, the at least one set of instructions causes the computing device to perform a method including: obtaining multi-dimensional image data, wherein the multi-dimensional image data is generated by a fluorescence microscopy; generating an initial multi-dimensional image based on the multi-dimensional image data; and constructing an objective function based on an acquisition process of the multi-dimensional image data, and generating a target image by performing one or more iterations on the initial multi-dimensional image according to the objective function. The objective function may include a fidelity term and a regularization term. The fidelity term may be related to an imaging physical model of the fluorescence microscopy. The regularization term may be determined using a regularization network.

According to an aspect of the present disclosure, a method for image processing is provided. The method is implemented on a machine having at least one processor and at least one storage device. The method may include: obtaining image data, wherein the image data is generated by a fluorescence microscopy; generating an initial image based on the image data; and generating a target image by processing the initial image according to an objective function. The objective function may be constructed based on an acquisition process of the image data. The objective function may include a fidelity term and a regularization term. The fidelity term may be related to an imaging physical model of the fluorescence microscopy. The regularization term may be determined using a regularization network.

### BRIEF DESCRIPTION OF THE DRAWINGS

The present disclosure is further described in detail of exemplary embodiments. These exemplary embodiments are described in detail with reference to the drawings. These embodiments are not limiting, and in these embodiments, the same number indicates the same structure, wherein:

FIG. 1 is a schematic diagram illustrating an exemplary application scenario of an image processing system according to some embodiments of the present disclosure;

FIG. 2 is a schematic diagram illustrating an exemplary computing device according to some embodiments of the present disclosure;

FIG. 3 is a block diagram illustrating an exemplary terminal according to some embodiments of the present disclosure;

FIG. 4 is a schematic diagram illustrating an exemplary processor according to some embodiments of the present disclosure;

FIG. 5 is a flowchart illustrating an exemplary process for image processing according to some embodiments of the present disclosure;

FIG. 6 is a flowchart illustrating an exemplary process for obtaining the image processing model via a training operation according to some embodiments of the present disclosure;

FIG. 7A is a schematic diagram illustrating the generation of the target image according to some embodiments of the present disclosure;

FIG. 7B is a schematic diagram illustrating an exemplary structure of the second sub-model according to some embodiments of the present disclosure;

FIG. 8A shows a reference image obtained using the conventional Wiener reconstruction method, a target image obtained using the image processing model provided by the present disclosure, and an image representing the corresponding true value (GT) according to some embodiments of the present disclosure;

FIG. 8B shows the Peak Signal-to-Noise Ratio (PSNR) and Structural Similarity (SSIM) of the target image and GT when changing λ and T according to some embodiments of the present disclosure;

FIG. 8C shows images of portions marked by the gray boxes in FIG. 8A according to some embodiments of the present disclosure;

FIG. 9A shows actin filaments under the super-resolution structured illumination microscopy (SR-SIM) according to some embodiments of the present disclosure;

FIG. 9B shows magnified views of the larger box regions marked by gray boxes in FIG. 9A reconstructed by Wiener deconvolution, HiFi-SIM, Hessian-SIM, and TDV-SIM, as well as the GT image according to some embodiments of the present disclosure;

FIG. 9C shows magnified views of the smaller box regions marked by gray boxes in FIG. 9A reconstructed by Wiener deconvolution, scU-Net, DFCAN, and TDV-SIM, as well as the GT image according to some embodiments of the present disclosure;

FIG. 9D shows endoplasmic reticulum (ER) under the SR-SIM;

FIG. 9E shows magnified views of the boxed regions in FIG. 9D reconstructed by Wiener deconvolution, HiFi-SIM, Hessian-SIM, scU-Net, DFCAN, and TDV-SIM, as well as the GT image;

FIG. 9F shows artifact variances of actin filaments from background regions in different reconstructions;

FIG. 9G shows artifact variances of ER tubules from background regions in different reconstructions;

FIG. 9H shows SSIM of actin filaments in different reconstructions;

FIG. 9I shows SSIM of ER tubules in different reconstructions;

FIG. 9J shows resolutions of different reconstructions of actin filaments in FIGS. 9A-9C;

FIG. 10A shows microtubules from the BioSR dataset under the SR-SIM reconstructed with different methods;

FIG. 10B shows magnified views of the larger boxed regions in FIG. 10A reconstructed by Wiener deconvolution, rDL SIM, NF-rDL SIM, and TDV-SIM;

FIG. 10C shows artifact variances of the background regions in different reconstructions;

FIG. 10D shows SSIM of microtubules in different reconstructions;

FIG. 11A shows mitochondria under the SR-SIM;

FIG. 11B shows time-dependent bleaching in fluorescence intensities of mitochondria;

FIG. 11C shows magnified views of the larger boxed region in FIG. 11A reconstructed by scU-Net, DFCAN, and TDV-SIM and the corresponding GT image at 0 s;

FIG. 11D shows magnified views of the smaller boxed region in FIG. 11 Are constructed by Wiener deconvolution, HiFi-SIM, Hessian-SIM, and TDV-SIM and the corresponding GT image at 0 s, 15 s, and 20 s;

FIG. 11E shows the SSIMs of regions enclosed mitochondria from different reconstructions compared to GT images at 0 s, 15 s, and 20 s;

FIG. 11F shows the artifact variances of the background regions in different reconstructions at 0 s, 15 s, and 20 s;

FIG. 12A shows the actin filaments under the NL SIM;

FIGS. 12B-12C show magnified views of the white boxed regions in FIG. 12A reconstructed by Wiener deconvolution, Hessian-SIM, DFCAN and TDV-NL-SIM;

FIG. 12D shows magnified views of the gray boxed regions in FIG. 12A reconstructed by Wiener deconvolution, Hessian-SIM, DFCAN and TDV-NL-SIM;

FIG. 12E shows artifact variances of actin filaments from background regions in different reconstructions;

FIG. 12F shows signal variance along the actin filaments in different reconstructions;

FIG. 12G shows SSIM of actin filaments in different reconstructions;

FIGS. 13A-13D are schematic diagrams illustrating another exemplary image processing method according to some embodiments of the present disclosure;

FIGS. 14A-14S illustrate an exemplary comparison result of TDV 3D-SIM with state-of-the-art 3D-SIM methods according to some embodiments of the present disclosure;

FIGS. 15A-15G illustrate TDV restoration improves CSDM imaging without signal temporal leakage and missing according to some embodiments of the present disclosure;

FIGS. 16A-16F illustrate TDV restoration improves live-cell dual-color time-lapse WFM and FLFM imaging of mitochondria and peroxisomes according to some embodiments of the present disclosure;

FIGS. 17A-17C illustrate exemplary diagrams of the Fourier-light-field microscopy (FLFM) according to some embodiments of the present disclosure;

FIG. 18 is a block diagram illustrating an exemplary image processing system according to some embodiments of the present disclosure;

FIG. 19 is a flowchart illustrating an exemplary process for image processing according to some embodiments of the present disclosure; and

FIG. 20 is a schematic diagram illustrating an exemplary training process of a regularization network according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that the term “object” and “subject” may be used interchangeably as a reference to a thing that undergoes an imaging procedure of the present disclosure.

It will be understood that the term “system,” “engine,” “unit,” “module,” and/or “block” used herein are one method to distinguish different components, elements, parts, sections or assemblies of different levels in ascending order. However, the terms may be displaced by another expression if they achieve the same purpose.

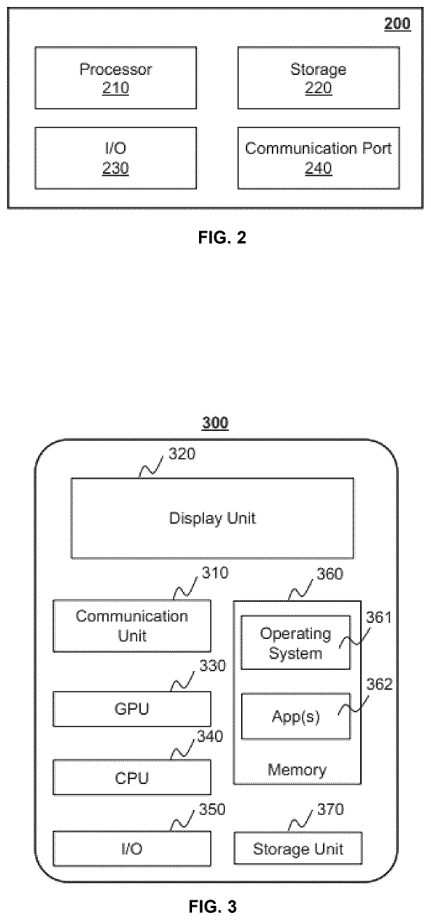

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or themselves, and/or may be invoked in response to detected events or interrupts. Software modules/units/blocks configured for execution on computing devices (e.g., processor 210 as illustrated in FIG. 2) may be provided on a computer-readable medium, such as a compact disc, a digital video disc, a flash drive, a magnetic disc, or any other tangible medium, or as a digital download (and can be originally stored in a compressed or installable format that needs installation, decompression, or decryption before execution). Such software code may be stored, partially or fully, on a storage device of the executing computing device, for execution by the computing device. Software instructions may be embedded in firmware, such as an EPROM. It will be further appreciated that hardware modules/units/blocks may be included in connected logic components, such as gates and flip-flops, and/or can be included in programmable units, such as programmable gate arrays or processors. The modules/units/blocks or computing device functionality described herein may be implemented as software modules/units/blocks but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may apply to a system, an engine, or a portion thereof.

It should be noted that when an operation is described to be performed on an image, the term “image” used herein may refer to a dataset (e.g., a matrix) that contains values of pixels (pixel values) in the image. As used herein, a representation of an object (e.g., a person, an organ, a cell, or a portion thereof) in an image may be referred to as the object for brevity. For instance, a representation of a cell or organelle (e.g., mitochondria, endoplasmic reticulum, centrosome, Golgi apparatus, etc.) in an image may be referred to as the cell or organelle for brevity. As used herein, an operation on a representation of an object in an image may be referred to as an operation on the object for brevity. For instance, a segmentation of a portion of an image including a representation of a cell or organelle from the image may be referred to as a segmentation of the cell or organelle for brevity.

It should be understood that the term “resolution” as used herein, refers to a measure of the sharpness of an image. The term “super-resolution” or “super-resolved” or “SR” as used herein, refers to an enhanced (or increased) resolution, e.g., which may be obtained by a process of combining a sequence of low-resolution images to generate a higher resolution image or sequence.

Conventional methods for reconstructing an image are usually based on the imaging principle of the image acquisition device (or a physical model reflecting the imaging principle of the image acquisition device). Images with a relatively high resolution (e.g., super-resolution microscopic images) generated by these conventional methods often include one or more artifacts or have an unsatisfying signal-noise ratio. With the development of image processing techniques, trained machine-learning models have the potential to generate a target image with high quality based on image data collected or generated by the image acquisition device. However, since the reconstruction process using a trained machine-learning model is not constrained by the imaging principle, the quality of the target image relies on the training sets used for obtaining the trained machine-learning models. As a result, images generated by the trained machine-learning model may include some errors.

According to the systems and methods of the present disclosure, the image data generated from the image acquisition device may be used to generate a preliminary image. The preliminary image may be optimized to generate the target image based on an objective function using an image processing model. The image processing model may include a first sub-model and a second sub-model. The first sub-model may be configured to determine a first optimization term related to a likelihood term of an objective function. The second sub-model may be configured to determine a second optimization term related to a regularization term of the objective function. The second sub-model may be a trained machine-learning model. The use of the trained machine-learning model is effective in reducing artifacts or noise in the target image. Moreover, the use of the likelihood term ensures that the reconstruction is based on the imaging principle, thus reducing or avoiding errors in the target image.

Moreover, although the systems and methods disclosed in the present disclosure are described primarily regarding the processing of images generated by structured illumination microscopy (SIM), it should be understood that the descriptions are merely provided for illustration, and not intended to limit the scope of the present disclosure. The systems and methods of the present disclosure may be applied to any other kind of system including an image acquisition device for image processing. For example, the systems and methods of the present disclosure may be applied to microscopes, telescopes, cameras (e.g., surveillance cameras, camera phones, webcams), unmanned aerial vehicles, medical imaging devices, or the like, or any combination thereof.

It should be understood that application scenarios of systems and methods disclosed herein are only some exemplary embodiments provided for illustration, and not intended to limit the scope of the present disclosure. For persons having ordinary skills in the art, multiple variations and modifications may be made under the teachings of the present disclosure.

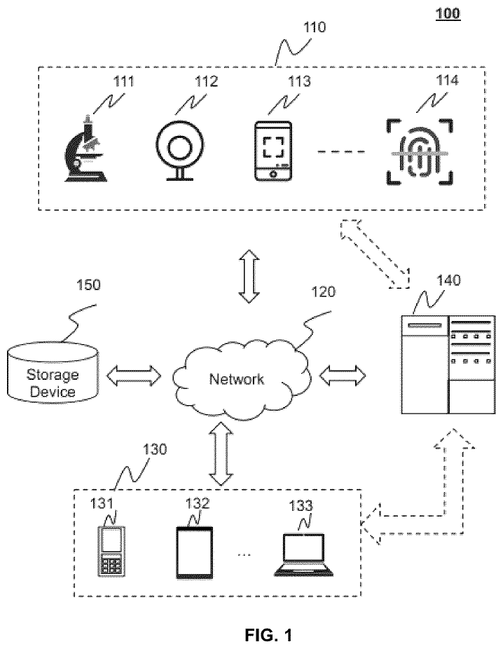

FIG. 1 is a schematic diagram illustrating an exemplary application scenario of an image processing system according to some embodiments of the present disclosure. As shown in FIG. 1, the image processing system 100 may include an image acquisition device 110, a network 120, one or more terminals 130, a processor 140, and a storage device 150.

The components in the image processing system 100 may be connected in one or more of various ways. Merely by way of example, the image acquisition device 110 may be connected to the processor 140 through the network 120. As another example, the image acquisition device 110 may be connected to the processor 140 directly as indicated by the bi-directional arrow in dotted lines linking the image acquisition device 110 and the processor 140. As still another example, the storage device 150 may be connected to the processor 140 directly or through the network 120. As a further example, the terminal 130 may be connected to the processor 140 directly (as indicated by the bi-directional arrow in dotted lines linking the terminal 130 and the processor 140) or through the network 120.

The image processing system 100 may be configured to generate a target image using an image processing model (e.g., as shown in process 500 of FIG. 5). The target image may be with a relatively high resolution that can extend beyond physical limits posed by the image acquisition device 110. For example, the image processing system 100 may obtain a plurality of raw cell images with a relatively low signal-noise ratio generated by the image acquisition device 110 (e.g., SIM). As another example, the image processing system 100 may obtain one or more images captured by the image acquisition device 110 (e.g., a camera phone or a phone with a camera). The one or more images may be blurred and/or with relatively low resolutions, as factors such as a shaking of the camera phone, moving of an object to be imaged, an inaccurate focusing, etc. during the capturing and/or physical limits posed by the camera phone. The image processing system 100 may process the image(s) by using the image processing model to generate one or more target images with relatively high quality. Thus, the image processing system 100 may display the target images(s) with a relatively high quality for a user of the image processing system 100.

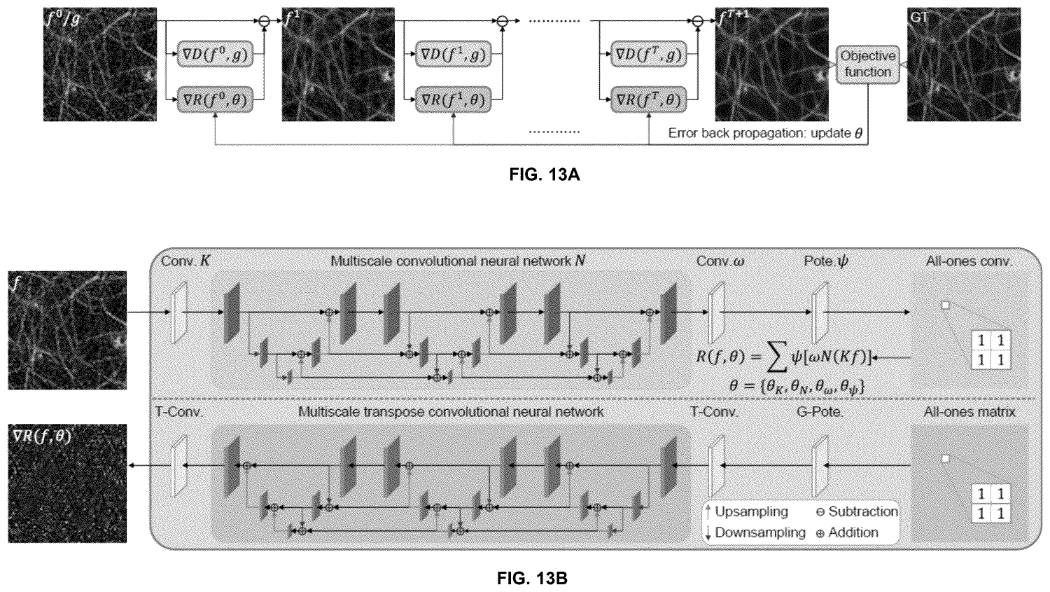

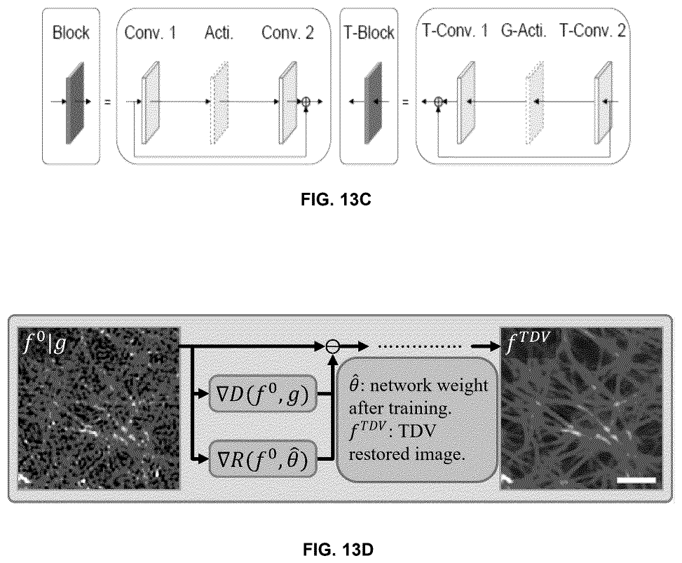

The image processing system 100 may be further configured to generate a target image by performing one or more iterations on an initial image (e.g., a raw cell image) based on an objective function. In some embodiments, the objective function may include a fidelity term and a regularization term. The fidelity term may be related to an imaging model of a microscopy that generates the initial image. The regularization term may be determined using a regularization network. More descriptions of the fidelity term and the regularization term may be found elsewhere in the present disclosure (e.g., Equation (10), FIGS. 13A-13B and descriptions thereof).

The image acquisition device 110 may be configured to obtain image data associated with a subject within its detection region. In the present disclosure, “object” and “subject” are used interchangeably. The subject may include one or more biological or non-biological objects. In some embodiments, the image acquisition device 110 may be an optical imaging device, a radioactive-ray-based imaging device (e.g., a computed tomography device), a nuclide-based imaging device (e.g., a positron emission tomography device), a magnetic resonance imaging device), etc. Exemplary optical imaging devices may include a microscope 111 (e.g., a fluorescence microscope), a surveillance device 112 (e.g., a security camera), a mobile terminal device 113 (e.g., a camera phone), a scanning device 114 (e.g., a flatbed scanner, a drum scanner, etc.), a telescope, a webcam, or the like, or any combination thereof. In some embodiments, the optical imaging device may include a capture device (e.g., a detector or a camera) for collecting the image data. For illustration purposes, the present disclosure may take the microscope 111 as an example for describing exemplary functions of the image acquisition device 110. Exemplary microscopes may include a structured illumination microscope (SIM) (e.g., a two-dimensional SIM (2D-SIM), a three-dimensional SIM (3D-SIM), a total internal reflection SIM (TIRF-SIM), a spinning-disc confocal-based SIM (SD-SIM), etc.), a photoactivated localization microscopy (PALM), a stimulated emission depletion fluorescence microscopy (STED), a stochastic optical reconstruction microscopy (STORM), a confocal spinning disk microscopy (CSDM), wide field microscopy (WFM) and Fourier light field microscopy (FLFM), etc. The SIM may include a detector such as an EMCCD camera, an sCMOS camera, etc. The subjects detected by the SIM may include one or more objects of biological structures, biological tissues, proteins, cells, microorganisms, or the like, or any combination. Exemplary cells may include INS-1 cells, COS-7 cells, Hela cells, liver sinusoidal endothelial cells (LSECs), human umbilical vein endothelial cells (HUVECs), HEK293 cells, or the like, or any combination thereof. In some embodiments, the one or more objects may be fluorescent or fluorescent-labeled. The fluorescent or fluorescent-labeled objects may be excited to emit fluorescence for imaging.

The network 120 may include any suitable network that can facilitate the image processing system 100 to exchange information and/or data. In some embodiments, one or more of components (e.g., the image acquisition device 110, the terminal(s) 130, the processor 140, the storage device 150, etc.) of the image processing system 100 may communicate information and/or data with one another via the network 120. For example, the processor 140 may acquire image data from the image acquisition device 110 via the network 120. As another example, the processor 140 may obtain user instructions from the terminal(s) 130 via the network 120. The network 120 may be and/or include a public network (e.g., the Internet), a private network (e.g., a local area network (LAN), a wide area network (WAN), etc.), a wired network (e.g., an Ethernet), a wireless network (e.g., an 802.11 network, a Wi-Fi network, etc.), a cellular network (e.g., a Long Term Evolution (LTE) network), an image relay network, a virtual private network (“VPN”), a satellite network, a telephone network, a router, a hub, a switch, a server computer, and/or a combination of one or more thereof. For example, the network 120 may include a cable network, a wired network, a fiber network, a telecommunication network, a local area network, a wireless local area network (WLAN), a metropolitan area network (MAN), a public switched telephone network (PSTN), a Bluetooth™ network, a ZigBee™ network, a near field communication network (NFC), or the like, or a combination thereof. In some embodiments, the network 120 may include one or more network access points. For example, the network 120 may include wired and/or wireless network access points, such as base stations and/or network switching points, through which one or more components of the image processing system 100 may access the network 120 for data and/or information exchange.

In some embodiments, a user may operate the image processing system 100 through the terminal(s) 130. The terminal(s) 130 may include a terminal 131, a tablet computer 132, a laptop computer 133, or the like, or a combination thereof. In some embodiments, the terminal 131 may include a smart home device, a wearable device, a mobile device, a virtual reality device, an augmented reality device, or the like. In some embodiments, the smart home device may include a smart lighting device, a control device of an intelligent electrical apparatus, a smart monitoring device, a smart television, a smart video camera, an interphone, or the like, or a combination thereof. In some embodiments, the wearable device may include a bracelet, footgear, glasses, a helmet, a watch, clothing, a backpack, a smart accessory, or the like, or a combination thereof. In some embodiments, the terminal(s) 130 may be part of the processor 140.

The processor 140 may process data and/or information obtained from the image acquisition device 110, the terminal(s) 130, and/or the storage device 150. For example, the processor 140 may process image data generated by the image acquisition device 110 to generate a target image with a relatively high quality. In some embodiments, the processor 140 may be a server or a server group. The server group may be centralized or distributed. In some embodiments, the processor 140 may be local or remote. For example, the processor 140 may access information and/or data stored in the image acquisition device 110, the terminal(s) 130, and/or the storage device 150 via the network 120. As another example, the processor 140 may be directly connected to the image acquisition device 110, the terminal(s) 130, and/or the storage device 150 to access stored information and/or data. In some embodiments, the processor 140 may be implemented on a cloud platform. For example, the cloud platform may include a private cloud, a public cloud, a community cloud, a distributed cloud, an interconnected cloud, a multiple cloud, or the like, or a combination thereof. In some embodiments, the processor 140 may be implemented by a computing device 200 having one or more components as described in FIG. 2.

The storage device 150 may store data, instructions, and/or any other information. In some embodiments, the storage device 150 may store data obtained from the terminal(s) 130, the image acquisition device 110, and/or the processor 140. In some embodiments, the storage device 150 may store data and/or instructions that the processor 140 may execute or use to perform exemplary methods described in the present disclosure. In some embodiments, the storage device 150 may include a mass storage device, a removable storage device, a volatile read-and-write memory, a read-only memory (ROM), or the like. In some embodiments, the storage device 150 may be executed on a cloud platform. For example, the cloud platform may include a private cloud, a public cloud, a community cloud, a distributed cloud, an interconnected cloud, a multiple cloud, or the like, or a combination thereof.

In some embodiments, the storage device 150 may be connected to the network 120 to communicate with one or more other components (e.g., the processor 140, the terminal(s) 130, etc.) of the image processing system 100. One or more components of the image processing system 100 may access data or instructions stored in the storage device 150 via the network 120. In some embodiments, the storage device 150 may be directly connected to or communicate with one or more other components (e.g., the processor 140, the terminal(s) 130, etc.) of the image processing system 100. In some embodiments, the storage device 150 may be part of the processor 140.

FIG. 2 is a schematic diagram illustrating an exemplary computing device according to some embodiments of the present disclosure. The computing device 200 may be used to implement any component of the image processing system 100 as described herein. For example, the processor 140 and/or the terminal(s) 130 may be implemented on the computing device 200, respectively, via its hardware, software program, firmware, or a combination thereof. Although only one such computing device is shown, for convenience, the computer functions relating to the image processing system 100 as described herein may be implemented in a distributed manner on a number of similar platforms, to distribute the processing load.

As shown in FIG. 2, the computing device 200 may include a processor 210, a storage 220, an input/output (I/O) 230, and a communication port 240.

The processor 210 may execute computer instructions (e.g., program code) and perform functions of the image processing system 100 (e.g., the processor 140) in accordance with the techniques described herein. The computer instructions may include, for example, routines, programs, objects, components, data structures, procedures, modules, and functions, which perform particular functions described herein. For example, the processor 210 may process image data obtained from any component of the image processing system 100. In some embodiments, the processor 210 may include one or more hardware processors.

Merely for illustration, only one processor is described in the computing device 200. However, it should be noted that the computing device 200 in the present disclosure may also include multiple processors, thus operations and/or method operations that are performed by one processor as described in the present disclosure may also be jointly or separately performed by the multiple processors. For example, if in the present disclosure the processor of the computing device 200 executes both operation A and operation B, it should be understood that operation A and operation B may also be performed by two or more different processors jointly or separately in the computing device 200 (e.g., a first processor executes operation A and a second processor executes operation B, or the first and second processors jointly execute operations A and B).

The storage 220 may store data/information obtained from any component of the image processing system 100. In some embodiments, the storage 220 may include a mass storage device, a removable storage device, a volatile read-and-write memory, a read-only memory (ROM), or the like, or any combination thereof.

In some embodiments, the storage 220 may store one or more programs and/or instructions to perform exemplary methods described in the present disclosure. For example, the storage 220 may store a program for the processor 140 to process images generated by the image acquisition device 110.

The I/O 230 may input and/or output signals, data, information, etc. In some embodiments, the I/O 230 may enable user interaction with the image processing system 100 (e.g., the processor 140). In some embodiments, the I/O 230 may include an input device and an output device. Examples of the input device may include a keyboard, a mouse, a touch screen, a microphone, or the like, or a combination thereof.

The communication port 240 may be connected to a network to facilitate data communications. The communication port 240 may establish connections between the processor 140 and the image acquisition device 110, the terminal(s) 130, and/or the storage device 150. The connection may be a wired connection, a wireless connection, any other communication connection that can enable data transmission and/or reception, and/or any combination of these connections. In some embodiments, the communication port 240 may be and/or include a standardized communication port, such as RS232, RS485, etc. In some embodiments, the communication port 240 may be a specially designed communication port. For example, the communication port 240 may be designed in accordance with the digital imaging and communications in medicine (DICOM) protocol.

FIG. 3 is a block diagram illustrating an exemplary terminal according to some embodiments of the present disclosure.

As shown in FIG. 3, the terminal 300 may include a communication unit 310, a display unit 320, a graphics processing unit (GPU) 330, a central processing unit (CPU) 340, an I/O 350, a memory 360, a storage unit 370, etc. In some embodiments, any other suitable component, including but not limited to a system bus or a controller (not shown), may also be included in the terminal 300. In some embodiments, an operating system 361 (e.g., iOS™, Android™, Windows™, etc.) and one or more applications (apps) 362 may be loaded into the memory 360 from the storage unit 370 in order to be executed by the CPU 340. The application(s) 362 may include a browser or any other suitable apps for receiving and rendering information relating to imaging, image processing, or other information from the image processing system 100 (e.g., the processor 140). User interactions with the information stream may be achieved via the I/O 350 and provided to the processor 140 and/or other components of the image processing system 100 via the network 120. In some embodiments, a user may input parameters to the image processing system 100, via the terminal 300.

In order to implement various modules, units and their functions described above, a computer hardware platform may be used as hardware platforms of one or more elements (e.g., the processor 140 and/or other components of the image processing system 100 described in FIG. 1). Since these hardware elements, operating systems and program languages are common; it may be assumed that persons skilled in the art may be familiar with these techniques and they may be able to provide information needed in the imaging and assessing according to the techniques described in the present disclosure. A computer with the user interface may be used as a personal computer (PC), or other types of workstations or terminal devices. After being properly programmed, a computer with the user interface may be used as a server. It may be considered that those skilled in the art may also be familiar with such structures, programs, or general operations of this type of computing device.

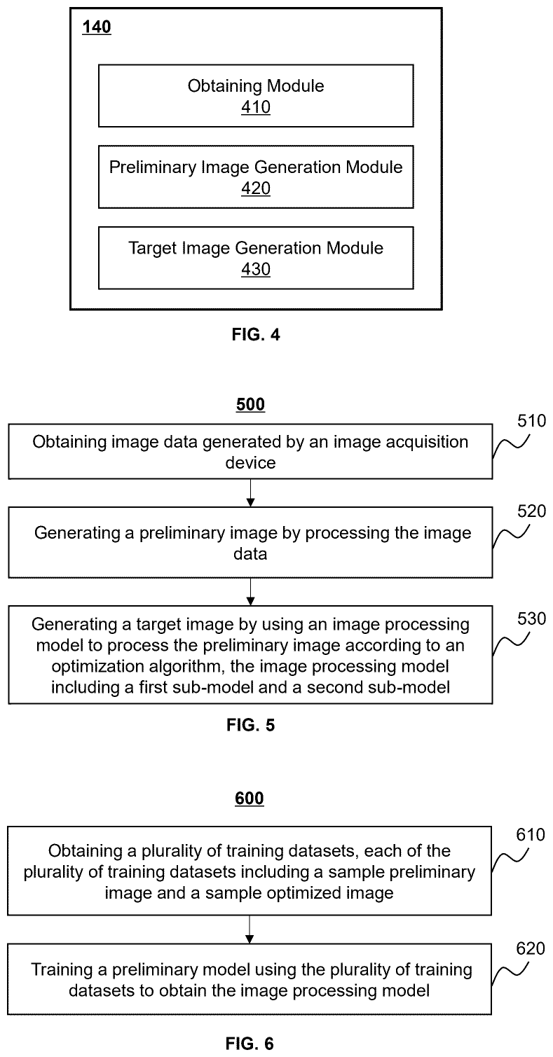

FIG. 4 is schematic diagrams illustrating an exemplary processor according to some embodiments of the present disclosure. As shown in FIG. 4, the processor 140 may include an obtaining module 410, a preliminary image generation module 420, and a target image generation module 430.

The obtaining module 410 may be configured to obtain information and/or data from one or more components of the image processing system 100. In some embodiments, the obtaining module 410 may obtain image data from the storage device 150 or the image acquisition device 110. As used herein, the image data may refer to raw data (e.g., one or more raw images) collected by the image acquisition device 110. More descriptions regarding obtaining the image data may be found elsewhere in the present disclosure (e.g., operation 510 in FIG. 5). In some embodiments, the obtaining module 410 may obtain an image processing model from the storage device 150.

The preliminary image generation module 420 may generate a preliminary image. In some embodiments, the preliminary image generation module 420 may determine the preliminary image by performing a filtering operation on the image data. Merely by way of example, the preliminary image generation module 420 may determine the preliminary image by performing Wiener filtering on one or more raw images. More descriptions regarding generating the preliminary image may be found elsewhere in the present disclosure (e.g., operation 520 in FIG. 5).

The target image generation module 430 may generate a target image based on the preliminary image using an image processing model according to an optimization algorithm. The image processing model may include a first sub-model and a second sub-model. The first sub-model may be configured to determine a first optimization term related to a likelihood term of an objective function. The second sub-model may be configured to determine a second optimization term related to a regularization term of the objective function. The second sub-model may be a trained machine-learning model. More descriptions regarding generating the target image may be found elsewhere in the present disclosure (e.g., operation 530 in FIG. 5).

It should be noted that the above description of modules of the processor 140 is merely provided for the purposes of illustration, and not intended to limit the present disclosure. In some embodiments, one or more modules may be added or omitted in the processor 140. In some embodiments, one or more modules in the processor 140 may be integrated into a single module to perform functions of the one or more modules.

FIG. 5 is a flowchart illustrating an exemplary process for image processing according to some embodiments of the present disclosure. In some embodiments, process 500 may be executed by the image processing system 100. For example, the process 500 may be implemented as a set of instructions (e.g., an application) stored in a storage device (e.g., the storage device 150, the storage 220, and/or the storage unit 370). In some embodiments, the process may be accomplished with one or more additional operations not described, and/or without one or more of the operations discussed. Additionally, the order in which the operations of the process as illustrated in FIG. 5 and described below is not intended to be limiting.

In 510, the processor 140 (e.g., the obtaining module 402) may obtain image data generated by an image acquisition device.

In some embodiments, the image data herein may refer to raw data (e.g., one or more raw images) collected by the image acquisition device 110. The raw image may have a relatively low signal-noise ratio (SNR) or is partially damaged, or the like. Merely by way of example, for a SIM system, the image data may include one or more sets of raw images collected by the SIM system. Each set of raw images may include a plurality of raw images (e.g., 9 raw images, 15 raw images) corresponding to different phases and/or directions of sinusoidal illumination patterns applied to the subject (e.g., a cell sample). That is, the plurality of raw images may be collected by the SIM system at the different phases and/or directions.

In some embodiments, the processor 140 may obtain the image data from one or more components of the image processing system 100. For example, the image acquisition device 110 may collect and/or generate the image data and store the image data in the storage device 150. The processor 140 may retrieve and/or obtain the image data from the storage device 150. As another example, the processor 140 may directly obtain the image data from the image acquisition device 110.

In 520, the processor 140 (e.g., the preliminary image generation module 420) may generate a preliminary image based on the image data.

In some embodiments, the processor 140 may determine the preliminary image (e.g., the SR image) by filtering the image data. Exemplary filtering operations may include Wiener filtering, inverse filtering, least-squares filtering, or the like, or any combination thereof. For example, for each set of raw images of the image data, the processor 140 may generate an image stack (i.e., the preliminary image) by performing Wiener filtering on the plurality of raw images in the set of raw images. Specifically, if each set of raw images includes 9 raw images, the processor 140 may combine the 9 raw images in the set of raw images into the preliminary image. The preliminary image may include information in each of the 9 raw images and have a higher resolution than each of the 9 raw images. In some embodiments, the filtering operation may be omitted. For example, for a camera phone system, the image data may include only one raw image, and the processor 120 may designate the only one raw image as the preliminary image.

In 530, the processor 140 (e.g., the target image generation module 430) may generate a target image by using an image processing model to process the preliminary image according to an optimization algorithm.

In some embodiments, the processor 140 may obtain an objective function for generating the target image. The objective function may include a likelihood term and a regularization term. The image processing model may be configured to perform multiple iterative operations for minimizing the result of the objective function. The target image may be an optimized result based on the preliminary image.

For instance, the objective function may be expressed as the following Equation

$${min}_{f} D ( f , g ) + λ R ( f ) , \qquad ( 1 )$$

where f refers to the target image; g refers to components of different orders obtained by a band separation operation (also referred to as a “frequency spectrum separation operation”); D(f, g) refers to the likelihood term; R(f) refers to the regularization term; 1 is a parameter representing the weight of the regularization term. Merely by way of example, the objective function may be solved using the gradient descent algorithm according to the following Equation (2):

$${f}^{k + 1} = {f}^{k} - η ∇ D ( {f}^{k} , g ) - η λ ∇ R ( {f}^{k} ) , \qquad ( 2 )$$

In some embodiments, the image processing model is a trained machine-learning model. The image processing model may be stored in the storage device 150 and may be obtained and used by the processor 140. Various portions of the image processing model may be configured to perform different processing operations. For instance, the image processing model may include a first sub-model and a second sub-model. The first sub-model may be configured to determine a first optimization term related to a likelihood term of an objective function. The second sub-model may be configured to determine a second optimization term related to a regularization term of the objective function. The second sub-model may also be a trained machine-learning model. More details regarding the training process for obtaining the image processing model may be found elsewhere in the present disclosure, for example, in FIG. 6.

In some embodiments, the optimization algorithm for generating the target image based on the preliminary image may include a Direct Fourier Transform (DFT) algorithm, a Filtered Back Projection (FBP) algorithm, an Algebraic Reconstruction Technique (ART), a Simultaneous Iterative Reconstruction Technique (SIRT), a Maximum Entropy (ME) method, or the like. The first optimization term and the second optimization term may be determined according to the optimization algorithm. For example, the optimization algorithm may be the gradient descent algorithm. The first optimization term may be a derivative of the likelihood term and the second optimization term may be a derivative of the regularization term.

To generate the target image using the image processing model, the processor 140 may perform a plurality of iterative operations based on the preliminary image. In a first iterative operation, the first sub-model may be configured to determine a first intermediate optimization term related to the likelihood term based on the preliminary image; the second sub-model may be configured to determine a second intermediate optimization term related to the regularization term based on the preliminary image. The image processing model may further include a third sub-model configured to generate an intermediate image based on the first intermediate optimization term, the second intermediate optimization term, and the preliminary image. The processor 140 may use the image processing model to perform a plurality of continuing iterative operations to update the intermediate image in a way that is similar to the first iterative operation until a termination criterion is met. When the processor 140 determines that the termination criterion is met, the intermediate image in the latest iterative operation may be determined as the target image. Alternatively, the processor 140 may further process the intermediate image in the latest iterative operation to obtain the target image. Such processing may include but not limited to adjusting the dimension of the intermediate image to make it suitable to be displayed on a screen, automatically adding one or more labels (such as a scale bar), etc.

In some embodiments, the termination criterion may relate to a value of the objective function. For example, the termination criterion may be satisfied if the result of the objective function is minimal or smaller than a threshold (e.g., a constant). As another example, the termination criterion may be satisfied if the value of the objective function converges. In some embodiments, convergence may be deemed to have occurred if the variation of the values of the objective function in two or more consecutive iterations is equal to or smaller than a threshold (e.g., a constant). In some embodiments, convergence may be deemed to have occurred if a difference between the value of the objective function (e.g., the value of the objective function) and a target value is equal to or smaller than a threshold (e.g., a constant). In some embodiments, the termination criterion may relate to an iterative number (count) of the objective function. For example, the termination criterion may be satisfied when a specified iterative number (or count) T of iterative operations have been performed. In some embodiments, the termination criterion may relate to an iterative time of the objective function (e.g., a time length that the first iterative operation is performed). For example, the termination condition may be satisfied if the iterative time of the objective function is greater than a threshold (e.g., a constant).

In some embodiments, at least one parameter related to the use of the image processing model may be set according to default settings or based on values designated by a user of the image processing system 100. For example, the parameter representing the weight of the regularization term 1 in the objective function shown in Equation (1) and/or the iterative number T may be chosen based on specific situations. The adjustment of these parameters may help improve the image quality of the target image. For example, the processor may firstly generate a target image based on default values of 1 and T. After the target image is presented to the user, the user may evaluate the image quality of the target image. If the user determines that the image quality is not satisfying enough (e.g., there is still some noise in the target image), the user may manually adjust the value(s) of 1 and/or T. The processor 140 may re-generate the target image according to the adjusted value(s) of λ and/or T. In some embodiments, there may be multiple value sets for λ and T stored in the storage device 150 of the image processing system 100, such as (λ₁, T₁), (λ₂, T₂), (λ₃, T₃), etc. The processor 140 may generate multiple target images according to the multiple value sets for λ and T. These target images may be presented to the user and the user may select one of the target images with the highest image quality for further observation or analysis.

In some embodiments, the likelihood term may be determined according to an imaging principle of the image acquisition device 110 (or a physical model reflecting the imaging principle). For illustration purposes, the following description relates to the reconstruction of SIM images. It should be noted that the process 500 may be applied to the reconstruction of other types of images as well.

When the subject being imaged has a finite size, there may be a unique analytic function that coincides inside the bandwidth-limited frequency spectrum band of the optical transfer function (OTF) of the image acquisition device 110, thus enabling the reconstruction of the complete object by extrapolating the observed spectrum. Firstly, illumination parameters may be estimated based on image data generated or collected by the image acquisition device 110. SR frequency spectrum components of different orders may be obtained through the band separation operation. For example, in the frequency domain, the SR frequency spectrum components may be expressed using the following Equation (3):

$${G}_{d , n} ( k ) = S ( k - {P}_{d , n} ) O ( k ) , \qquad ( 3 )$$

where d and n refer to the direction of the illumination pattern and the order of the frequency spectrum, respectively; S(k) refers to the frequency spectrum of an actual fluorescence distribution of the subject; P_{d,n} refers to a pattern wave vector of the illumination pattern; 0(k) refers to the OTF of the image acquisition device 110.

Equation (2) may be converted to obtain the following Equation (4) in the space domain:

$${g}_{d , n} ( r ) = [ t ( r ) \times s ( r ) ] * H ( r ) , \qquad ( 4 )$$

wherein s(r) refers to the spatial distribution of the actual fluorescence distribution; H(r) refers to a point spread function of the image acquisition device 110 obtained via a reverse Fourier transformation operation on the OTF; t(r) is a phase matrix for moving the frequency spectrum of s(r). In some embodiments, t(r) may be expressed using the following Equation (5)

$${t}_{d , n} ( r ) = {e}^{j 2 π {P}_{d , {n}^{r}}} , \qquad ( 5 )$$

where j is the imaginary unit.

According to Equation (3), the components of different orders g modulated by the OTF may be obtained from the target image if the pattern wave vectors, starting phase and modulation depth of the illumination pattern is known. Thus, the likelihood term may be expressed based on a two-norm form of the difference between g_{d,n} obtained from the image data generated by the image acquisition device 110 and the components of different orders obtained from the intermediate image. In some embodiments, the likelihood term may be expressed using the following Equation (6):

$$D ( f , g ) = {\sum }_{d , n} {‖ ( {t}_{d , n} \times f ) * H - {g}_{d , n} ‖}_{2}^{2} , \qquad ( 6 )$$

To make it more convenient for calculation, Equation (6) may be converted to the following Equation (7):

$$D ( f , g ) = {\sum }_{d , n} {‖ {F}^{- 1} O {Ft}_{d , n} f - {g}_{d , n} ‖}_{2}^{2} , \qquad ( 7 )$$

where F and F⁻¹ refers to a Fourier transformation operation and a reverse Fourier transformation operation, respectively.

The derivative of D(f,g) may be expressed using the following equation (8):

$$∇ D ( f , g ) = {\sum }_{d , n} {t}_{d , n}^{H} {F}^{- 1} {O}^{H} F ( {F}^{- 1} O {Ft}_{d , n} f - {g}_{d , n} ) , \qquad ( 8 )$$

where the superscript H means conjugate transpose.

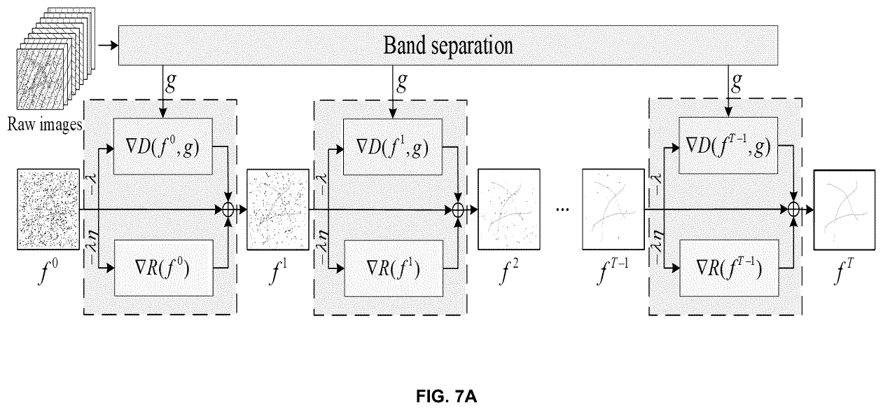

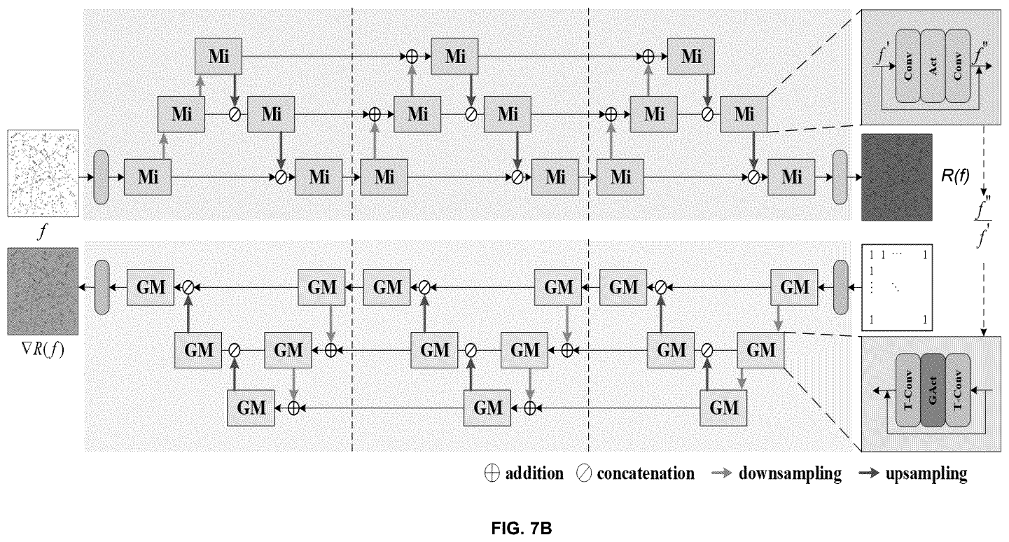

In some embodiments, the regularization term may be determined using a regularization term determination model, which may be a trained machine-learning model. For instance, the preliminary image may be inputted to the regularization term determination model, and the regularization term determination model may output an image representing the regularization term. Merely by way of example, the regularization term determination model may determine the regularization term based on total deep variation (TDV) regularization, Tikhonov regularization, total variation (TV) regularization, or sparsity regularization, or the like, which is not limited by the present disclosure. In some embodiments, the regularization term determination model may be a portion of the second sub-model. The determination of the second optimization term (e.g., a derivative) may be performed based on the regularization term by another portion of the second sub-model. For instance, FIG. 7B shows an exemplary structure of the second sub-model based on TDV regularization. The structure of the regularization term determination model may be represented by the upper portion of the model structure shown in FIG. 7B.

More details regarding the structure of the second sub-model may be found elsewhere, e.g., in the FIG. 7B and the descriptions thereof.

Merely by way of example, a TDV regularization term may be expressed using the following Equation (9):

$$R ( f ) = {w}^{T} N ( Kf ) , \qquad ( 9 )$$

where K refers to a convolution kernel with zero-average-value constrain; N refers to a convolution neural network; w is a weight vector.

It should be noted that the above description of the process 500 is merely provided for purposes of illustration, and not intended to limit the scope of the present disclosure. In some embodiments, process 500 may include one or more additional operations. For example, an additional operation may be added after operation 530 for displaying the target image. As another example, an additional operation may be added after operation 520 for pre-processing the preliminary image.

FIG. 6 is a flowchart illustrating an exemplary process for obtaining the image processing model via a training operation according to some embodiments of the present disclosure. In some embodiments, process 600 may be executed by the image processing system 100. For example, the process 600 may be implemented as a set of instructions (e.g., an application) stored in a storage device (e.g., the storage device 150, the storage 220, and/or the storage unit 370). In some embodiments, the process may be accomplished with one or more additional operations not described, and/or without one or more of the operations discussed. Additionally, the order in which the operations of the process as illustrated in FIG. 6 and described below is not intended to be limiting.

In 610, the processor 140 may obtain a plurality of training datasets, each of the plurality of training datasets including a sample preliminary image and a sample optimized image.

In some embodiments, the signal-noise ratio of the sample optimized image may be higher than that of the corresponding sample preliminary image in the same training dataset. For example, the sample preliminary image may be an image generated based on image data generated by the image acquisition device 110, which may include noise and artifacts. The corresponding sample optimized image may be generated by reducing the noise and artifacts in the sample preliminary image using various techniques.

As another example, the sample optimized image may be a simulated SIM image without noise (or the noise is negligible). The corresponding sample preliminary image may be a simulated SIM image including noise. Specifically, a red green blue (RGB) image may be converted to a grayscale image. An edge detection operation may be performed on the grayscale image to obtain an edge image. The detected edges may be determined as simulated fluorescence distribution. A simulated structure light may be applied to the edge image followed by a convolution operation using the point spread function of the image acquisition device 110. Then a down-sampling operation may be performed on the resultant image to obtain the sample optimized image. The corresponding sample preliminary image may be generated by adding simulated uneven fluorescence background and noise to the sample optimized image.

In 630, the processor 140 may train a preliminary model using the plurality of training datasets to obtain the image processing model.

The preliminary model may be trained using various methods, such as the gradient descent algorithm, which is not limited by the present disclosure. During the training process, model parameters of the preliminary model are updated to obtain the image processing model. The model parameters are updated to minimize a difference between the sample optimized image and an optimized image output by the preliminary model based on the sample preliminary image.

As described earlier, the image processing model (or the preliminary model) may include a first sub-model and a second sub-model. The first sub-model may be configured to determine a first optimization term related to a likelihood term of an objective function. The second sub-model may be configured to determine a second optimization term related to a regularization term of the objective function. During the training process, model parameters related to the second sub-model may be updated while model parameters related to the first sub-model remain the same.

In some embodiments, multiple image processing models corresponding to different types of training datasets may be stored in the storage device 150. For instance, the different types of training datasets may include training datasets corresponding to different types of subjects, training datasets corresponding to different imaging parameters (e.g., illumination parameters, exposure parameters), training datasets corresponding to different levels of signal-noise ratio, training datasets corresponding to different types of image acquisition devices, etc. Merely by way of example, a specific image processing model may be trained using a plurality of training sets corresponding to a specific type of subject, such as an actin ring, a nuclear pore complex structure, mitochondrial cristae, or the like. The processing device 140 may obtain the image processing model corresponding to the type of the imaged subject. For example, the processing device 140 may identify the type of the imaged subject using an image recognition technique based on the raw images collected by the image acquisition device 140. As another example, the processing device 140 may identify the type of the imaged subject according to subject information inputted by a user.

It should be noted that the above description of the process 600 is merely provided for purposes of illustration, and not intended to limit the scope of the present disclosure. In some embodiments, process 500 may include one or more additional operations. For example, an additional operation may be added after operation 620 for testing the performance of the image processing model. If the performance of the image processing model does not meet the requirements of the user, a further training operation may be performed on the image processing model, and/or a new group of training sets may be used for the training process.

FIG. 7A is a schematic diagram illustrating the generation of the target image according to some embodiments of the present disclosure. For illustration purposes, the target image is a SIM image.

As shown in FIG. 7A, a band separation operation may be performed on the raw images to determine SR frequency spectrum components of different orders. The raw images may include multiple images corresponding to different directions and different phases of illumination pattern. A preliminary image f⁰ may be generated based on the raw images. A first iterative operation may be formed on f⁰ to obtain an intermediate image f¹. A plurality of continuing iterative operations may be performed to update f¹ so as to obtain the final target image f^{T}. Here T refers to the iterative number. In each iteration, the image processing model determines a derivative of the likelihood term and a derivative of the regularization term. The intermediate images f¹, f², . . . , and f^{T-1} are updated based on the derivative of the likelihood term and the derivative of the regularization term.

FIG. 7B is a schematic diagram illustrating an exemplary structure of the second sub-model according to some embodiments of the present disclosure. For illustration purposes, the second sub-model is shown in FIG. 7B is a deep learning network based on TDV regularization.

The second sub-model may include two portions. A first portion (e.g., the upper portion shown in FIG. 7B) of the second sub-model is configured to determine a regularization term of the objective function. A second portion (e.g., the lower portion shown in FIG. 7B) of the second sub-model is configured to determine an optimization term corresponding to the regularization term (e.g., a derivative of the regularization term).

The first portion of the second sub-model includes three U-Net structures each consisting of five micro-blocks including residual structures. After the input image f is inputted into the first portion of the second sub-model, a regularization term R(f) is obtained by the first portion. To determine the derivative of R(f), an image matrix of which each element equals 1 is inputted to the second portion of the second sub-model. A reverse calculation is conducted according to the structure of the first portion of the second sub-model. During the reverse calculation of the second portion of the second sub-model, the convolutional layers of the second portion are modified to be the transposed convolution layers; the activation function layer of the second portion is modified to be a derivative of the activation function of the first portion.

The present disclosure is further described according to the following examples, which should not be construed as limiting the scope of the present disclosure.

In the present disclosure, an exemplary TDV restoration method is developed by interpretably combining the camera noise model with the deep learning (DL) which can improve the fluorescence microscopy (FM) (e.g., the structured illumination microscopy (SIM), confocal spinning disk microscopy (CSDM), wide field microscopy (WFM), Fourier light field microscopy (FLFM), etc.). In some embodiments, the TDV restoration method can be integrated into an SIM image enhancement framework and realize high contrast, high signal continuity, high structural integrity, artifacts free, long term (e.g., 3.5 h) and high resolution (e.g., sub 45 nm resolution) SIM imaging. In some embodiments, the TDV FM may be used to handle 3D-SIM image volumes of F-actin filaments, showing that the TDV FM enables superior restorations competitive with three other state-of-the-art methods. In some embodiments, the TDV FM may be used to promote degraded five-dimensional 3D-SIM data, enabling artifacts-free and high-fidelity super-resolution (SR) restorations. In some embodiments, the TDV FM may be used for restoration in CSDM, enabling high-SNR and high-contrast 2D/3D time-lapse imaging without signal temporal leakage and missing. It is demonstrated that TDV FM is capable of completely eliminating noise and artifacts for long-term WFM planer and FLFM volumetric imaging as a generic restoration method.

An exemplary principle of the TDV FM is described below.

In some embodiments, the FM image restoration process may be transformed into a hybrid optimization function including a fidelity term (e.g., the camera noise model based fidelity term D(f,g)) and a regularization term (e.g., the deep learning (DL) based regularization term R(f,θ)):

$${f}^{TDV} = {arg min}_{f} D ( f , g ) + R ( f , θ ) , \qquad ( 10 )$$

where f^{TDV} is the TDV restored image, g is the degraded data and θ is the network weight. Iteratively optimized restoration may be obtained using the gradient descent algorithm:

$${f}^{T + 1} = {f}^{T} - ∇ D ( {f}^{T} , g ) - ∇ R ( {f}^{T} , θ ) , \qquad ( 11 )$$

where T is the iteration number, V is the gradient operator (see FIG. 13A).

An exemplary DL regularization term network (see FIG. 13B) may be devised. In some embodiments, the DL regularization term network may include: (1) a convolution kernel K; (2) a multiscale convolutional neural network N including a plurality of blocks (see FIG. 13C); (3) a convolution kernel w; (4) a potential function ψ. In some embodiments, the partial derivative of the regularization term ∇R(f,θ) may be calculated by inverting the network, transforming a convolution layer into a transpose convolution layer with the same kernel, transforming an activation function into a gradient of the activation function, transforming the potential function into a gradient of the potential function and transforming the plurality of blocks into a plurality of transpose blocks (see FIGS. 13B-13C). After completing the DL regularization term network training, TDV FM can inference restorations with high quality (see FIG. 13D).

FIGS. 13A-13D are schematic diagrams illustrating another exemplary image processing method according to some embodiments of the present disclosure. FIG. 13A shows an iteratively optimized restoration process of TDV FM and the schematic of its training phase. FIG. 13B shows an architecture of the DL-based regularization term and its gradient. FIG. 13C shows an architecture of the Block and T-Block in FIG. 13B. Conv.: convolution layer; Pote.: potential function; Acti.: activation layer; T-Block: Transpose block; T-Conv.: Transpose convolution layer; G-Pote.: gradient of potential function; G-Acti.: gradient of activation layer. FIG. 13D shows the schematic of the inference phase of TDV FM.

Exemplary dataset acquisition, pre-processing and DL regularization term training is described below.

For TIRF-SIM imaging, the similar or same settings in Hessian SIM equipped with a wide-field objective (×150/1.45 oil, Olympus) may be used. For 3D-SIM imaging, the similar or same settings in HIS-SIM may be used. For CSDM imaging, the CSDM may be a commercial system based on an inverted fluorescence microscope (IX81, Olympus) equipped with a wide-field objective (x100/1.3 oil, Olympus) and a scanning confocal system (CSU-X1, Yokogawa). Four laser beams of 405 nm, 488 nm, 561 nm and 647 nm may be combined with the CSDM. The images may be captured either by an sCMOS camera (C14440-20UP, Hamamatsu) or an EMCCD camera (iXon3 897, Andor). For FLFM imaging, the similar or same settings in HR-FLFM may be used. To obtain low SNR raw images and the corresponding ground truth (GT) images of TIRF-SIM, 3D-SIM, CSDM and FLFM for training the TDV FM DL regularization term, the specimen may be imaged with high illumination laser intensity and exposure time as the GT raw images and a noise may be added following the fluorescence microscopy camera imaging noise model to the GT raw images as the low SNR raw images.

For each imaging modality and sample, approximately 30 cells may be imaged, and the images may be preprocessed to obtain pairs of raw data and corresponding GT image. Next, such image pairs may be divided into a training set, a validation set, and a test set. Then, random cropping, quarter rotating, and/or horizontal/vertical flipping may be applied to further enrich the training dataset. The TDV FM may be trained using an Adam optimizer, with a learning rate set to 1×10⁻⁴. A combination of a mean square error (MSE) loss and a structural similarity index measurement (SSIM) loss may be adopted as an integral with the objective function defined as:

$$L ( x , y ) = MSE ( x , y ) + k [ 1 - SSIM ( x , y ) ] , \qquad ( 12 )$$

where x and y denote the predicted images and the clear GT images, k is the weighting scalar to balance the contribution of SSIM and MSE losses. In some embodiments, k may be set to 0.2 empirically.

Exemplary assessment metrics calculation and statistical analysis is described below.

To quantitatively evaluate the performance of TDV FM and other computational 3D-SIM approaches, 3D PSNR and 3D SSIM between the GT volumes and the restored volumes may be calculated. The GT volumes y may be normalized in the range of [0, 1] and then a linear transformation may be applied to the restored volumes x to match its dynamic range with y:

$$\hat{x} = ax + b , \qquad ( 13 )$$

$$( a , b ) = {arg min}_{( α , β ) ∈ {ℝ}^{2}} ( {‖ α x + β - y ‖}_{2}^{2} ) , \qquad ( 14 )$$

Then, the 3D PSNR and 3D SSIM can be calculated between the normalized GT volumes y and linearly transformed volumes \hat{x}. Because there is no GT in real imaging data, the fluorescence intensity variances of the background regions (such as the meshed region within actin filaments) may be used to evaluate the amplitude of the artifacts, and the fluorescence intensity variances along the actin filaments may be used to evaluate the continuity of the signals. Furthermore, the signal integrality of the actin with the filaments length and density calculated along the protocol in BF SIM may be evaluated. Moreover, the resolution of different restorations with the FWHM (full width at half maximum) value measured along the protocol in Hessian SIM and the minimal FRC (Fourier ring correlation) value in the rFRC (rolling FRC) map computed by PANEL may be evaluated. Quantitative data may be presented as box-and-whisker plots (center line, average; limits, 75% and 25%; whiskers, maximum and minimum) in graphs.

Exemplary FLFM numerical point spread function (PSF) generation is described below.

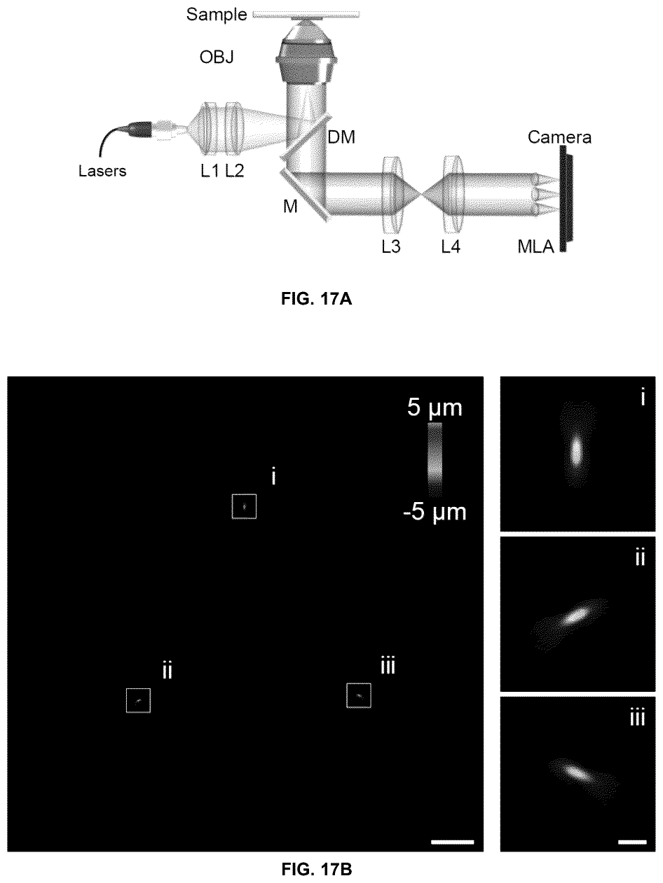

An exemplary FLFM system may be shown in FIG. 17A. The wavefunction at the native image plane (NIP) may be derived using the vectorial Debye theory:

$$U ( \vec{r} , \vec{p} ) = \frac{M}{{f}_{obj}^{2} {λ}_{em}^{2}} {\int }_{0}^{α} \sqrt{cos θ} sin θ {e}^{i [ \frac{2 π Φ ( l )}{{λ}_{em}} + \frac{u cos \hat{θ}}{4 {sin}^{2} ( α / 2 )} ]} \\ \{ ( {τ}_{s} + {τ}_{p} cos \hat{θ} ) {J}_{0} [ \frac{sin θ}{sin a} v ] - ( {τ}_{s} - {τ}_{p} cos \hat{θ} ) {J}_{2} [ \frac{sin θ}{sin a} v ] \} d θ , \qquad ( 15 )$$

where \vec{i}=(rₓ,r_{y}) is the NIP coordinates; \vec{p}=(pₓ,p_{y},p_{z}) is the sample volumetric coordinates; M, NA and f_{obj} are the objective lens magnification, numerical aperture and focal length, respectively; λₑₘ is the emission wavelength; a is the total internal reflection critical angle defined as Equation (16); θ and \hat{θ} are the refractive (objective lens side) and incident (sample side) angles at the interface between the immersion medium (refractive index=n₁) and the sample solution (refractive index=n₂); χ(•) is the aberration function defined as Equation (17); l is the normal focusing position; τₛ and τₚ are the Fresnel transmission coefficients defined as Equation (18) and Equation (19); u and v are normalized radial and axial coordinates defined as Equation (20) and Equation (21); J₀ and J₂ are the 0^{th} and 2^{th} order Bessel functions of the 1^{st} kind.

$$α = min [ {sin}^{- 1} ( NA / {n}_{1} ) , {sin}^{- 1} ( {n}_{2} / {n}_{1} ) ] , \qquad ( 16 )$$

$$Φ ( l ) = - l ( {n}_{1} cos θ - {n}_{2} cos \hat{θ} ) , \qquad ( 17 )$$

$${τ}_{s} = \frac{2 sin \hat{θ} cos θ}{sin ( θ + \hat{θ} )} , \qquad ( 18 )$$

$${τ}_{p} = \frac{2 sin \hat{θ} cos θ}{sin ( θ + \hat{θ} ) cos ( θ + \hat{θ} )} , \qquad ( 19 )$$

$$u = \frac{8 π {p}_{z} {n}_{2}}{{λ}_{em}} {sin}^{2} ( \frac{α}{2} ) , \qquad ( 20 )$$

$$v = \frac{2 π {n}_{1}}{{λ}_{em}} \sqrt{{( \frac{{r}_{x}}{M} - {p}_{x} )}^{2} + {( \frac{{r}_{y}}{M} - {p}_{y} )}^{2}} , \qquad ( 21 )$$

Since the isotropic polarization of the fluorescence emitters, pₓ=p_{y}=0 may be set, and the light field only points to the p_{z} direction may be derived for computational convenience.

In some embodiments, U(\vec{r},\vec{p}) may be optically Fourier transformed as OFT[U(\vec{r},\vec{p})] by the Fourier lens and modulated by the MLA as OFT[U(\vec{r},\vec{p})]Φ(\vec{m}), in which Φ(•) is the MLA transmission function defined as Equation (22), \vec{m}=(mₓ,m_{y}) may be the MLA coordinates.

$$ϕ ( \vec{m} ) = [ amp ( \vec{\frac{m}{d}} ) {e}^{- \frac{i π}{{f}_{mla} {λ}_{em}} {‖ \vec{m} ‖}_{2}^{2}} ] ⊗ comb ( \vec{\frac{m}{d}} ) , \qquad ( 22 )$$

where amp(•) is the MLA amplitude mask function, comb(•) is the MLA comb function, d and fₘₗₐ are the MLA single microlens diameter and focal length, respectively, \textcircled{x} is the convolution operator.

In some embodiments, the Fresnel propagation may be used to model the light field propagation from the MLA to camera:

$$h ( \vec{q} , \vec{p} ) = \{ OFT [ U ( \vec{r} , \vec{p} ) ] ϕ ( \vec{m} ) \} ⊗ IFT [ {e}^{2 π i {f}_{mla} \sqrt{{( \frac{1}{{λ}_{em}} )}^{2} - {‖ {f}_{\vec{q}} ‖}_{2}^{2}}} ] , \qquad ( 23 )$$

where \vec{q}=(qₓ,q_{y}) and f_{\vec{q}}=(f_{qx},f_{qy}) are the camera plane spatial and frequency coordinates, respectively, IFT is the inverse Fourier transform operator.

In some embodiments, the numerical FLFM PSF H(•) may be generated as:

$$H ( \vec{q} ) = \int δ ( \vec{p} ) {‖ h ( \vec{q} , \vec{p} ) ‖}^{2} d \vec{p} , \qquad ( 24 )$$

where δ(•) is the Dirac function.

Exemplary FLFM three-dimensional (3D) reconstruction is described below.

For a sample volume with spatial fluorescence intensity distribution s(\vec{p}), its corresponding observed raw image e(\vec{q}) acquired by the FLFM can be calculated as:

$$e ( \vec{q} ) = \int s ( \vec{p} ) {‖ h ( \vec{q} , \vec{p} ) ‖}^{2} d \vec{p} , \qquad ( 25 )$$

In some embodiments, the matriculated representation of Equation (25) can be expressed as:

$$E = HS , \qquad ( 26 )$$

where E, H and S are determined by the observed image, PSF (FIG. 17B) and sample volume of the FLFM. In some embodiments, FLFM 3D reconstruction can be transformed into an optimization problem defined as Equation (27) which can be iteratively solved by the Richardson-Lucy (RL) deconvolution as Equation (28).

$${arg min}_{S} KL ( E , HS ) , \qquad ( 27 )$$

$${S}^{( k + 1 )} = \frac{{HH}^{T} {S}^{( k )}}{{H}^{T} E} {S}^{( k )} , \qquad ( 28 )$$

where KL(•) is the Kullback-Leible divergence, (•)^{T} is the matrix transpose operator, k is the iteration number, S^{(k)} is the k^{th} reconstruction.

In some embodiments, the hybrid PSF of the experimental PSF (providing the intensity distributions) and the numerical PSF (providing the spatial locations) may be employed for the FLFM 3D reconstruction (FIG. 17C).

FIGS. 17A-17C illustrate exemplary diagrams of the Fourier-light-field microscopy (FLFM) according to some embodiments of the present disclosure. FIG. 17A shows a schematic diagram of the FLFM setup. OBJ: objective; M: mirror; DM: dichroic mirror; MLA: microlens array; L1-L4: lenses. FIG. 17B shows FLFM hybrid point spread function (hybrid PSF) distribution, color-coded for distance from the focal plane. Magnified views of the boxed regions corresponding to microlenses (i)-(iii) are on the right. FIG. 17C shows an exemplary generation pipeline of the hybrid PSF. Scale bars, 10 μm (FIG. 17B, left) and 2 μm (FIG. 17B, right).

An exemplary 3D-SIM imaging physical model is described below.

Compared to conventional 3D wide-field fluorescence microscopy, 3D-SIM may double the spatial and axial resolution by excitating the volumetric sample s(\vec{p}) with the pattern illumination iᵣₙ(\vec{p}) generated by the interference of three beams of light. Regardless of the imaging noise, the fluorescence emission distribution eᵣₙ(\vec{r}) detected by the camera can be expressed as:

$${e}_{rn} ( \vec{r} ) = \int [ s ( \vec{p} ) {i}_{rn} ( \vec{p} ) ] {‖ U ( \vec{r} , \vec{p} ) ‖}^{2} d \vec{p} , \qquad ( 29 )$$

where r and n are the illumination pattern orientation and phase index, respectively, \vec{r}=(rₓ,r_{y}) is the NIP coordinates, \vec{p}=(pₓ,p_{y},p_{z}) is the sample volumetric coordinates, U(\vec{r},\vec{p}) is the NIP wavefunction calculated as Equation (15). The pattern illumination i(\vec{p}) can be calculated as:

$${i}_{rn} ( \vec{p} ) = N {\vert 1 + 2 \sqrt{\frac{{I}_{o}}{{I}_{n}}} {e}^{\frac{2 π i ( 1 - cos θ ) {p}_{z}}{{λ}_{ex}}} cos [ \frac{2 π sin θ}{{λ}_{ex}} ( cos {φ}_{r} {p}_{x} + sin {φ}_{r} {p}_{y} ) + {ψ}_{rn} ] \vert}^{2} , \qquad ( 30 )$$

where N is the normalization factor defined as Equation (31), Iₒ and Iₙ are the intensity of the obliquely and normally incident plane waves, respectively, λₑₓ is the excitation wavelength, θ is the incidence polar angle, φᵣ is the azimuthal angle for illumination pattern of r^{th} orientation, ψᵣₙ is the phase for illumination pattern of r^{th} orientation and n^{th} phase.

$$N = \frac{{I}_{n}}{{M}_{r} {M}_{n} ( {I}_{n} + 2 {I}_{o} )} , \qquad ( 31 )$$

where Mᵣ and Mₙ are the illumination pattern orientation and phase number, respectively.

The matriculated representation of Equation (29) can be expressed as:

$${E}_{rn} = {I}_{rn} S , \qquad ( 32 )$$

where Eᵣₙ and S are determined by the observed image and the sample volume, respectively, Iᵣₙ is determined by the structured illumination pattern and PSF of the 3D-SIM.

Exemplary 3D-SIM illumination pattern parameter estimation and super-resolution (SR) reconstruction is described below.

The parameters of 3D-SIM illumination pattern may be estimated using the auto and cross-correlation algorithm. In some embodiments, 3D-SIM SR reconstruction can be transformed into a regularized Least Squares (LS) minimization problem defined as:

$${arg min}_{S} {\sum }_{r , n} {‖ {E}_{rn} - {I}_{rn} S ‖}_{2}^{2} + λ R ( S ) , \qquad ( 33 )$$

where R(S) is the appended regularization term based on the a-prior knowledge of the sample and λ is the regularizer weight. For conventional 3D-SIM SR reconstruction, the Wiener regularizer may be widely employed and the corresponding minimization problem can be solved analytically by the Wiener deconvolution.

An exemplary CSDM imaging physical model is described below.

CSDM may be used to scan the sample s(\vec{p}) with the multiple focused laser beam i(\vec{q}) and detect the fluorescence intensity e(\vec{r},\vec{q}) of each laser beam by focusing through the corresponding confocal circular pinhole A(\vec{r}) onto the camera. The fluorescence intensity e(\vec{r},\vec{q}) can be calculated as:

$${e ( \vec{r} , \vec{p} ) = \int A ( \vec{r} ) s ( \vec{p} ) i ( \vec{q} - \vec{p} ) ‖ U ( \vec{r} , \vec{p} - \vec{q} ) ‖}^{2} d \vec{p} , \qquad ( 34 )$$

where \vec{r}=(rₓ,r_{y}) is the NIP coordinates, \vec{p}=(pₓ,p_{y},p_{z}) is the sample volumetric coordinates, \vec{q}=(qₓ,q_{y},q_{z}) is the focused laser beam center coordinates, U(\vec{r},\vec{p}) is the NIP wavefunction calculated as Equation (15). The circular pinhole A(\vec{r}) describes the action of the confocal aperture and is given by:

$$A ( \vec{r} ) = \{ \begin{matrix}1 , if {‖ \vec{r} ‖}_{2}^{2} < {a}^{2} \\ 0 , if {‖ \vec{r} ‖}_{2}^{2} > {a}^{2}\end{matrix} , \qquad ( 35 )$$

where a is the radius of the confocal aperture when back-projected into the NIP space.

If the Stokes shift between excitation and emission wavelength is neglected and it is assumed that the confocal aperture of the microscope does not significantly restrict light detection laterally (i.e., the excitation intensity distribution has fallen off to negligible values before the presence of the confocal aperture makes itself tangible), then the matriculated representation of Equation (34) can be approximately and simplifily expressed as:

$$E = HS , \qquad ( 36 )$$

where E and S are determined by the observed image and sample, respectively, H is determined by the multiple focused laser beam illumination pattern and PSF of the CSDM.

An exemplary CSDM deconvolution is described below.

As a kind of low photon imagery technique, the fluorescence emission of CSDM may be well-approximated by the Poisson process. Then Equation (36) can be transformed as:

$$E ∼ Poisson ( HS ) , \qquad ( 37 )$$

where Poisson(HS) is the Poisson distribution with parameter (mean or variance) equals to HS. Maximizing the posterior probability P(E|HS) with a multiplicative gradient-based algorithm may lead to the RL deconvolution algorithm expressed as Equation (28).

An exemplary fluorescence microscopy camera imaging noise model is described below.

In EMCCD and sCMOS cameras, imaging noise may mainly include shot noise, thermal noise, and/or readout noise. Shot noise may stem from the photon detection process. Thermal noise and readout noise may originate from the electronics built around the detector chip. When photons are detected on the camera sensor chip, the analog-to-digital unit (ADU) count output of the camera may follow a probability distribution which can be describe by the convolution of a Poisson distribution and a Gaussian distribution, in which the Poisson distribution may represent the shot noise of photon detection and the Gaussian distribution may be a result of the readout noise. The conditional probability density function (CPDF) for an individual pixel i of the camera can be described by the following equation:

$$P ( {C}_{i} \vert {E}_{i} ) = A {\sum }_{q = 0}^{∞} \frac{1}{q !} {e}^{- {E}_{i}} {E}_{i}^{q} \frac{1}{\sqrt{2 π {var}_{i}}} {e}^{- \frac{{( D - q \cdot {k}_{i} - {o}_{i} )}^{2}}{2 {var}_{i}}} , \qquad ( 38 )$$

where Cᵢ represents the specific counts obtained by the camera in that pixel (in units of ADU), A is a normalization constant, Eᵢ is the number of expected photoelectrons (e−), kᵢ is the amplification gain (ADUs/e−) for pixel i, and oᵢ and varᵢ stand for mean (offset) and variance of the readout noise of pixel i, respectively.

For the convenience of later deduction, the distribution of random variables Cᵢ can be equivalently expressed as:

$${C}_{i} = {P}_{i} + {G}_{i} + {o}_{i} , \qquad ( 39 )$$

where Pᵢ follows the Poisson distribution with mean value and variance value equal to kᵢEᵢ:

$${P}_{i} ∼ P ( {k}_{i} {E}_{i} ) , \qquad ( 40 )$$

Gᵢ follows the Gaussian distribution with mean value equals to zero and variance value equals to varᵢ:

$${G}_{i} ∼ N ( 0 , {var}_{i} ) , \qquad ( 41 )$$

In some embodiments, a new random variable Zᵢ can be defined and expressed as:

$${Z}_{i} = \frac{{C}_{i} - {o}_{i}}{{k}_{i}} + \frac{{var}_{i}}{{k}_{i}^{2}} , \qquad ( 42 )$$

If the mean (or variance) of a Poisson distribution is large, it can be approximate to a Gaussian distribution. Then the distribution of Zᵢ may approximately follow the Gaussian distribution and can be expressed as:

$${Z}_{i} ∼ N ( \frac{{var}_{i}}{{k}_{i}^{2}} + {E}_{i} , \frac{{var}_{i}}{{k}_{i}^{2}} + {E}_{i} ) , \qquad ( 43 )$$

For simplification, the Eᵢ term in the variance of Zᵢ is ignored, and then the approximate CPDF of Zᵢ can be expressed as:

$$P ( {Z}_{i} \vert {E}_{i} ) = \frac{{k}_{i}}{\sqrt{2 {πvar}_{i}}} e \frac{{( {k}_{i}^{2} {Z}_{i} - {k}_{i}^{2} {E}_{i} - {var}_{i} )}^{2}}{2 {k}_{i}^{2} {var}_{i}} , \qquad ( 44 )$$

The approximate CPDF of Cᵢ can be calculated by substituting the Zᵢ in Equation (44) with Equation (42) and expressed as:

$$P ( {C}_{i} \vert {E}_{i} ) = \frac{{k}_{i}}{\sqrt{2 π {var}_{i}}} {e}^{- \frac{{( {C}_{i} - {k}_{i} {E}_{i} - {o}_{i} )}^{2}}{2 v a {r}_{i}}} , \qquad ( 45 )$$

Based on the derivation above, the image formation of the fluorescence microscopy (FM) including 3D-SIM, CSDM and FLFM can be treated as the linear models defined as Equation (32), (36) and (26) which can be unified into the form as:

$$E = {H}_{FM} S , \qquad ( 46 )$$

where H_{FM} is the FM linear physical model, S is the sample fluorophores spatial distribution to be restored, E is the camera observations (or the number of expected photoelectrons). In some embodiments, the sample fluorophores spatial distribution S can be restored by maximizing the posterior probability defined as:

$${arg max}_{S} P ( S \vert C ) = {arg max}_{S} {\prod }_{i} P ( S \vert {C}_{i} ) , \qquad ( 47 )$$

where P (S|Cᵢ ) can be calculated with the Bayesian rules and expressed as:

$$P ( S \vert {C}_{i} ) = \frac{P ( {C}_{i} \vert S ) P ( S )}{P ( {C}_{i} )} ∝ P ( {C}_{i} \vert S ) P ( S ) , \qquad ( 48 )$$

In some embodiments, the restoration optimization function J(S) may be defined as the negative logarithm of P (S|C) and calculated by combining Equations (45), (46), (47) and (48). The simplified form of J(S) can be expressed as the linear inverse problem defined as:

$${arg min}_{S} J ( S ) = {arg min}_{S} [ {‖ \frac{C - o}{k} - {H}_{FM} S ‖}_{2}^{2} + R ( S ) ] , \qquad ( 49 )$$

where the first part of J(S) represents the fidelity term and the second part of J(S) (i.e., R(S)) represents the regularization term defined as the negative logarithm of P(S) corresponding to the a prior knowledge of the sample distribution from the statistical viewpoint.

An exemplary deep learning based regularization term is described below.

An appropriate regularizer that captures the complex statistics of the sample may be essential. Various mathematically handcrafted regularizers are developed, while the complexity of the fluorescence sample is only partially reflected in their formulation. Deep learning (DL) may provide strong expressiveness and can approximate the complex sample volume distribution with infinitesimal errors theoretically. So a DL-based regularization term may be used to substitute the conventional handcrafted regularizers R(S) as a more proper statistical model of the sample distribution, in which θ is the learned DL network weights. Meanwhile, the pseudo-inverse function

$${H}_{FM}^{- 1}$$

of the FM physical model may be applied to both terms within the fidelity term for the convenience of subsequent optimization problem solving. In some embodiments, Equation (19) can be rewritten as a hybrid optimization problem of the camera noise model based fidelity term with the DL based regularization term:

$${f}^{TDV} = {arg min}_{f} D ( f , g ) + {R}_{TDV} ( f , θ ) , \qquad ( 50 )$$

where f^{TDV} is the TDV restoration of the sample fluorophores spatial distribution (i.e., S) and g is the conventional restoration defined as

$${H}_{FM}^{- 1} ( \frac{C - o}{k} ) .$$

In some embodiments, the inverse problem (Equation (50)) can be solved iteratively by the gradient descent algorithm as:

$${f}^{T + 1} = {f}^{T} - {∇}_{f} ( D ( f , g ) ) {\vert}_{f = {f}^{T}} - {∇}_{f} ( {R}_{TDV} ( f , θ ) ) {\vert}_{f = {f}^{T}} , \qquad ( 51 )$$

where T is the iteration number, f^{T} is the T^{th} restoration, ∇_{f} is the gradient operator. The partial derivative of the fidelity term ∇_{f}(D(f,g)) can be calculated as:

$${∇}_{f} ( D ( f , g ) ) = f - g , \qquad ( 52 )$$

The partial derivative of the regularization term ∇R(f,θ) can be calculated along the pipeline in FIGS. 13B-13C.

Exemplary CSDM synthetic data generation is described below.

The islet zinc ions secretion CSDM images may be modeled as the superposition of multiple PSFs of the imaging system. In some embodiments, the equivalent PSF of CSDM may be generated with Equation (34) by setting the sample volumetric coordinates \vec{p} as (0, 0, 0). In some embodiments, the apodization filter A(\vec{r}) defined as Equation (53) may be applied to the PSF for avoiding the oscillation detrimental to the convergence of the subsequent DL regularization training.

$$A ( \vec{r} ) = \{ \begin{matrix}cos ( \frac{π}{2} \cdot \frac{\vert \vec{r} \vert}{R} ) , & \vert \vec{r} \vert \leq R \\ 0 , & \vert \vec{r} \vert > R\end{matrix} , \qquad ( 53 )$$

where \vec{r}=(rₓ,r_{y}) is the NIP coordinates, R is the full width at half maximum (FWHM) of the PSF. The location map and intensity map of zinc ions secretion may be generated randomly. The zinc ions secretion mask may be generated by the multiplication of the location map and the intensity map. The ground truth (GT) image of zinc ions secretion may be synthesized by the convolution of the zinc ions secretion mask and the apodised PSF. The degration from GT images to noisy images may be implemented by adding the noise following the fluorescence microscopy camera imaging noise model and well-registered data may be produced for the subsequent DL regularization term training.

By interpretably incorporating the advantages of both optical front-end (e.g., camera imaging noise model) and algorithmic back-end (e.g., DL) methodologies, TDV FM can generically improve live cell five-dimensional (5D) (x-y-z-time-color) fluorescence imaging. The advantages of TDV FM methods may include: (1) TDV FM is proposed based on the statistical analytical image formation model of the fluorescence microscopy and the corresponding iteratively restoration process is completely statistically interpretable; (2) compared to the conventional algorithms employing handcrafted analytical models with certain assumptions to iteratively restore images, TDV FM substitutes the handcrafted assumptive analytical models with more proper DL based analytical models, largely promoting the quality of the final restorations; (3) TDV FM is demonstrated on the image restoration of multifarious fluorescence imaging modalities as a widely compatible and generic method.

In conclusion, TDV FM provide a generic and interpretable solution for noise-free, artifacts-free, high-fidelity, high-contrast and long-term (e.g., 3.5 h) restoration with up to high resolution (e.g., sub-45-nm resolution) from low SNR images. Endorsed with reduced photon dosage and associated photon toxicity, improved imaging speed, and extended imaging duration and color dimension, TDV FM may be crucial for shedding light on diverse biological phenomena.

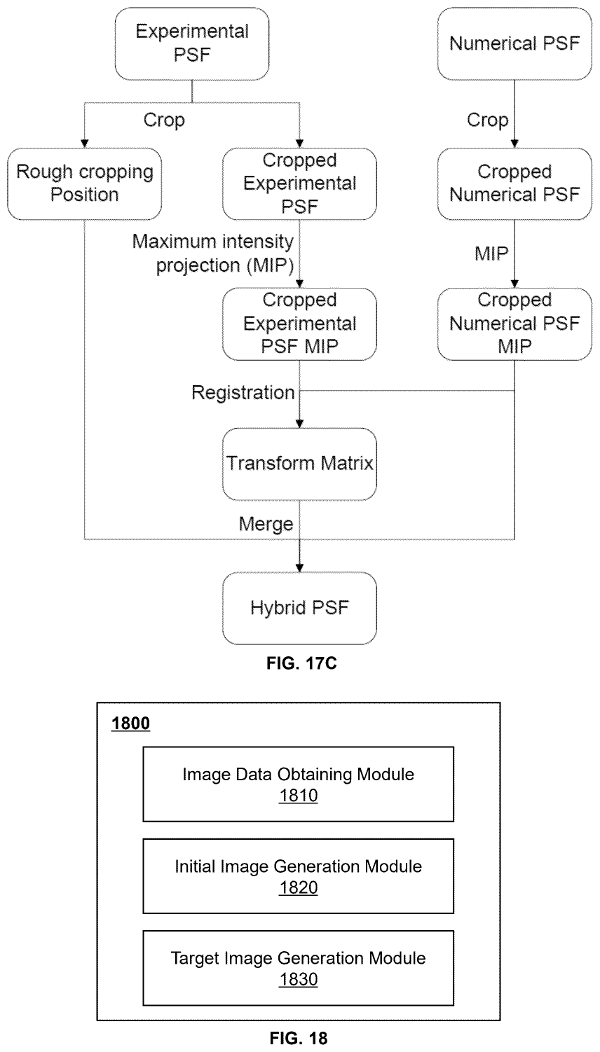

FIG. 18 is a block diagram illustrating an exemplary image processing system according to some embodiments of the present disclosure. As shown in FIG. 18, the image processing system 1800 may include an image data obtaining module 810, an initial image generation module 1820, and a target image generation module 1830.

The image data acquisition module 810 may be configured to obtain multi-dimensional image data. The multi-dimensional image data may be generated by the fluorescence microscopy. In some embodiments, the image data obtaining module 810 may obtain the multi-dimensional image data from the storage device 150 or the image acquisition device 110 (e.g., a fluorescence microscopy). As used herein, the multi-dimensional image data may refer to raw data (e.g., one or more raw three-dimensional images) acquired by the image acquisition device 110. More descriptions of the obtaining of the multi-dimensional image data may be found elsewhere in the present disclosure (e.g., operation 1910 and descriptions thereof).

The initial image generation module 820 may be configured to generate an initial multi-dimensional image based on the multi-dimensional image data. In some embodiments, the initial multi-dimensional image generation module 820 may generate the initial multi-dimensional image by performing a filtering operation on the multi-dimensional image data. Merely by way of example, the initial image generation module 820 may generate the initial multi-dimensional image by performing a Wiener filtering on one or more raw three-dimensional images. More descriptions of the generation of the initial multi-dimensional image may be found elsewhere in the present disclosure (e.g., operation 1920 and descriptions thereof).

The target image generation module 830 may be configured to construct an objective function based on an acquisition process of the multi-dimensional image data, and/or generate a target image by performing one or more iterations on the initial multi-dimensional image. The objective function may include a fidelity term and a regularization term. The fidelity term may be related to an imaging model of the fluorescence microscopy. The regularization term may be determined using the regularization network. More descriptions of the generation of the target image may be found elsewhere in the present disclosure (e.g., operation 1930 and descriptions thereof).

It should be noted that the above descriptions of the modules of the image processing system 1800 are merely provided for the purpose of illustrating and are not intended to limit the present invention. In some embodiments, one or more modules may be added or omitted in the image processing system 1800. In some embodiments, the one or more modules in the image processing system 1800 may be assembled into a single module to perform the functions of the one or more modules.

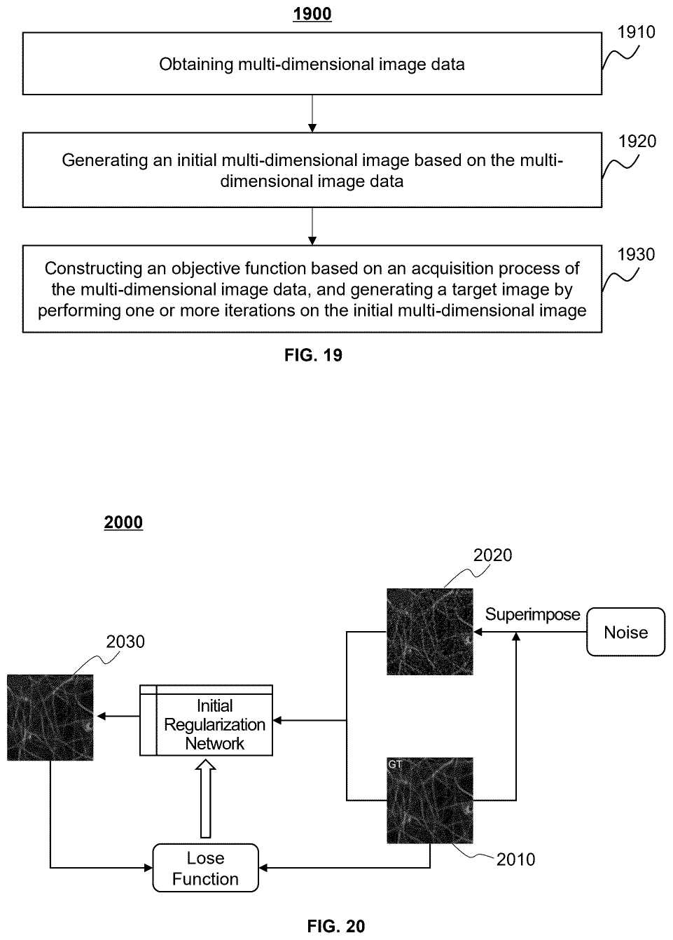

FIG. 19 is a flowchart illustrating an exemplary process for image processing according to some embodiments of the present disclosure. In some embodiments, one or more operations in process 1900 may be executed by a processing device (e.g., a processor 140 or a processor 210). For example, the process 1900 may be implemented as a set of instructions (e.g., an application program) stored in a storage device (e.g., the storage device 150). In some embodiments, the processing device may execute the set of instructions to implement one or more operations in the process 1900.

In 1910, multi-dimensional image data may be obtained.

The multi-dimensional image data may refer to raw data generated by the image acquisition device 110 (e.g., a fluorescence microscopy). For example, the multi-dimensional image data may include one or more raw three-dimensional images obtained by 3D-SIM. The multi-dimension of the image data may include a spatial dimension, a temporal dimension, a sample dimension, or the like, or any combination thereof. More descriptions of the fluorescence microscopy may be found elsewhere in the present disclosure (e.g., FIG. 1 and the related descriptions thereof).

Merely by way of example, for 3D-SIM, the multi-dimensional image data may include a plurality of sets of 3D raw image data. Each set of 3D raw image data obtained may include or correspond to a plurality of raw images (e.g., 9 raw images, 15 raw images, etc.) corresponding to different phases and/or orientations of a sinusoidal illumination pattern applied to an object (e.g., a cell sample). That is, the structured illumination microscopy may acquire a plurality of 3D raw images at different phases and/or orientations, to obtain the multi-dimensional image data. It should be noted that in some other embodiments, the multi-dimensional image data may be generated by CSDM or FLFM, or any other fluorescence microscopy, which is not limited in the present disclosure.

In 1920, an initial multi-dimensional image may be generated based on the multi-dimensional image data.

The initial multi-dimensional image may be a 3D image obtained through processing (e.g., a reconstruction processing or filtering, etc.) the multi-dimensional image data. In some embodiments, the processing device may determine the initial multi-dimensional image by performing a filtering operation on the multi-dimensional image data. In some embodiments, the filter may include a Wiener filter, an inverse filter, a least squares filter, etc., or any combination thereof.

Continuing with the aforementioned example of 3D-SIM, for each set of 3D raw images in the multi-dimensional image data, the processing device may generate an image stack by respectively performing the filtering operation (e.g., Wiener filtering) on each 3D raw image in the set of 3D raw images, to obtain the initial multi-dimensional image. Specifically, if each set of 3D raw images include nine 3D raw images, the processing device may combine the nine 3D raw images in the set of 3D raw images to obtain the initial multi-dimensional image, so that the initial multi-dimensional image may have a higher spatial resolution than the 3D raw images.

In 1930, an objective function may be constructed based on an acquisition process of the multi-dimensional image data, and/or a target image may be generated by performing one or more iterations on the initial multi-dimensional image according to the objective function.

The acquisition process may reflect an imaging principle of the fluorescence microscopy. The imaging principle of the fluorescence microscopy may be expressed by an imaging physical model of the fluorescence microscopy and/or a noise model of the imaging. More descriptions of the imaging physical model and the noise model of the imaging may be found elsewhere in the present disclosure (e.g., Equations. (10)-(53) and descriptions thereof). In some embodiments, the objective function may include a fidelity term and a regularization term. In some embodiments, the regularization term may be determined using a regularization network.

The regularization network may be a DL model obtained by training with training samples. The training samples may include images with relatively high signal-to-noise ratios. More descriptions of obtaining the training samples and the training of the regularization network may be found in FIG. 20 and the related description thereof.

In some embodiments, an input of the regularization network may be the initial multi-dimensional image (i.e., the initial multi-dimensional image may be input into the regularization network), in which the fidelity term and/or a partial derivative of the fidelity term may be determined based on the imaging physical model of the fluorescent microscopy and the initial multi-dimensional image. The initial multi-dimensional image may be input into the DL-based regularization network to determine the regularization term. By using the DL-based regularization network, in which a prior distribution of relatively high SNR images in the training samples and picture properties (e.g., a spatial-temporal continuity, a sparsity, etc.) corresponding to different objects in the training samples is learnt, quality of an image processing result of the initial multi-dimensional image may be improved.

The objective function may represent a mathematical expression of an optimization objective to be achieved by model optimization (e.g., image processing) during regularization network execution. In some embodiments, the fidelity term may be related to the imaging physical model of the fluorescence microscopy. The fidelity term may indicate a consistency degree of the 3D image with the imaging physical model inherent to the fluorescence microscopy. It should be understood that the fidelity term may be determined based on an imaging principle of the fluorescence microscopy, and since there may be a plurality of kinds of fluorescence microscopies, the imaging principles and the inherent imaging physical models of the fluorescence microscopies may be different, the expressions of the fidelity terms may also be different. For example, the imaging principles of the fluorescence microscopies including 3D-SIM, CSDM, and FLFM, etc., are different, different fidelity terms may be used respectively.

The regularization term in the objective function may be determined through the DL-based regularization network. More descriptions of the regularization term and the DL-based regularization network may be found elsewhere in the present disclosure (e.g., FIGS. 13A-13D, 20 and the related descriptions thereof).

In some embodiments, in a process of generating the target image, a minimization objective function may be used, and one or more iterations may be performed. If a count of iterations reaches a pre-set number (e.g., 500 or 1000 iterations), or a value of the objective function obtained by a current iteration satisfies a pre-set condition (e.g., the value of the objective function converges or is less than a pre-set threshold), the iterations may be terminated.

In some embodiments, the objective function may be similar to Equation (50), which may be expressed as:

$${f}^{TDV} = {arg min}_{f} D ( f , \hat{g} ) + {R}_{TDV} ( f , θ ) , \qquad ( 54 )$$

where f^{TDV} denotes a target image generated after iteration(s), f denotes the initial multi-dimensional image, D(f,ĝ) denotes the fidelity term, and ĝ denotes a conventional restoration image; R_{TDV}(f,θ) denotes the regularization term, θ denotes a weight parameter of the DL-based regularization network. In some embodiments, the conventional restoration image may be a preset (e.g., manually preset) image related to the fluorescence microscopy. In some embodiments, the conventional restoration image may reflect a restoration image relating to the imaging principle of the fluorescence microscopy and an inherent imaging physical model thereof.

In some embodiments, one or more weighting factors may be added to the fidelity term and/or the regularization term to reflect a focus of the result on the fidelity term and/or the regularization term. The present description does not impose any limitation on the manner of weighting.

In some embodiments, an optimization algorithm may be used to perform one or more iterations to minimize the objective function, thereby adjusting the 3D image. Merely by way of example, an optimization algorithm may include a direct Fourier transform (DFT) algorithm, a filtered back projection (FBP) algorithm, an algebraic reconstruction technique (ART), a simultaneous iterative reconstruction technique (SIRT), a maximum entropy (ME) process, or the like. In some embodiments, at least one of the fidelity term and the regularization term may be determined based on the optimization algorithm.

It should be noted that the foregoing descriptions of the process 1900 are merely provided for the purpose of illustration and are not intended to limit the scope of application of the present disclosure.

Referring to FIG. 13B, an exemplary regularization network may include a multi-scale convolutional neural network. In some embodiments, the regularization network may include a first convolutional layer, a multi-scale convolutional neural network, a second convolutional layer, a potential function, and an all-1 convolutional layer. In some embodiments, the regularization network may further include an activation function (i.e., an activation layer). By setting the multi-scale convolutional neural network, spatial resolutions of the 3D images (e.g., the initial multi-dimensional image, an output image of the previous iteration) input to the regularization network may be inconsistent, and accordingly, there is no need for an additional normalization operation to unify the spatial resolutions of the 3D images input to the regularization network.

Continuing with the example of 3D-SIM in the previous disclosure, since the 3D image includes in-plane information in an x-axis direction and a y-axis direction relative to the two-dimensional image, and there is additional information about a dimension in a z-axis direction, the use of the multi-scale convolutional neural network enables the z-axis direction to be more continuous (i.e., more features between multi-layer two-dimensional images) during the recovery of the 3D image, and the fidelity during restoration of each layer can be improved. In some embodiments, the multi-scale convolutional neural network of the regularization term may include one or more convolutional kernels with different receptive fields, and the convolutional kernels with different receptive fields may be configured to extract features between layers of the initial multi-dimensional image, thereby obtaining one or more feature images of the multi-dimensional image with a spatial resolution lower than a spatial resolution of an input multi-dimensional image (e.g., the initial multi-dimensional image, an output image of the previous iteration).

In some embodiments, one or more convolutions may be performed on the input multi-dimensional image or a feature image based on the one or more convolutional kernels with different receptive fields. Merely by way of example, in response to that an input of the multi-scale convolutional neural network is a 3D image, the size and/or count of convolutional kernels with different receptive fields may be different depending on the spatial resolution of the 3D image and the structure of the multi-scale convolutional neural network (e.g., the sizes of the convolutional kernels with different receptive fields may be 3×3×3, or 5×5×5, etc.).

In some embodiments, each iteration in the one or more iterations may include: determining a partial derivative of the fidelity term based on the conventional restoration image and an output image of a previous iteration of the current iteration; determining a partial derivative of the regularization term based on the output image of the previous iteration; and determining an output image of the current iteration based on the partial derivative of the fidelity term, the partial derivative of the regularization term, and the output image of the previous iteration.

Continuing with the example that the objective function is Equation (54) in the foregoing disclosure, in some embodiments, in response to that the current iteration is a (T+1)^{th} iteration, each iteration in a plurality of iterations performed on the initial multi-dimensional image may be expressed as:

$${f}^{T + 1} = {f}^{T} - ∇ D ( {f}^{T} \hat{g} ) - ∇ {R}_{TDV} ( {f}^{T} , θ ) , \qquad ( 55 )$$

where f^{T} is a 3D image output from the T^{th} iteration (i.e., the previous iteration), f^{T+1} is a 3D image obtained from the current iteration, and ∇D(f^{T},ĝ) denotes the partial derivative of the fidelity term, and ∇R_{TDV}(f^{T},θ) denotes the partial derivative of the regularization term.

Since the output image of the previous iteration f^{T} and the conventional restoration image ĝ are known, a determination process of the partial derivative of the fidelity term ∇D(f,ĝ) may include: determining the conventional restoration image based on the imaging physical model of the fluorescence microscopy; and determining the partial derivative of the fidelity term based on the conventional restoration image, the output image of the previous iteration, and a preset relationship between the partial derivative of the fidelity term, the conventional restoration image, and the output image of the previous iteration.

The preset relationship may be related to the noise of the imaging physical model of the fluorescence microscopy (e.g., 3D-SIM, CSDM, WFM, and FLFM), representing the relationship between the conventional restoration image and the output image of the previous iteration. More descriptions of determining the partial derivative of the fidelity term based on the conventional restoration image, the output image of the previous iteration and the preset relationship may be found in the foregoing Equations (49) and (52) and related descriptions thereof, which will not be repeated herein.

In some embodiments, a process of determining the partial derivative of the regularization term based on the output image of the previous iteration may further include: reserving the regularization network to obtain a reserved regularization network; and determining the partial derivative of the regularization term based on the reserved regularization network.

Specifically, in some embodiments, an all-1 matrix may be input to a reversed regularization network, and an output of the reversed regularization network may be the partial derivative of the regularization term. The all-1 matrix may be a matrix in which the values of all elements are 1.

In some embodiments, the reversing the regularization network may include: transforming a convolutional layer of the regularization network into a transpose convolutional layer with a same convolutional kernel; transforming an activation function of the regularization network into a gradient of the activation function; transforming a potential function of the regularization network into a gradient of the potential function; and transforming one or more blocks of the regularization network into one or more transpose blocks.

As described above, the regularization network may include a first convolutional layer, a multi-scale convolutional neural network, a second convolutional layer, a potential function, and an all-1 convolutional layer that is sequentially connected. The reserved regularization network may include a gradient of the potential function, a transpose second convolutional layer, a multi-scale transpose convolutional neural network and a transpose first convolutional layer that are sequentially connected. The multi-scale transpose convolutional neural network may be obtained by transforming blocks in the multi-scale convolutional neural network into transpose blocks. A transmission direction of the multi-scale transpose convolutional neural network may be opposite to a transmission direction of the multi-scale convolutional neural network.

After determining the partial derivative of the regularization term through the reserved regularization network, the output image of the current iteration may be determined based on Equation (55) in the foregoing disclosure; in response to that the current iteration is the last iteration or the output image of the current iteration meets preset condition(s), the output image of the current iteration may be designated as the target image.

It should be noted that the above description of process 1900 is merely provided for the purposes of illustration, and not intended to limit the scope of the present disclosure. For example, image data may be obtained. The image data may be generated by a fluorescence microscopy. An initial image may be generated based on the image data. A target image may be generated by processing the initial image according to an objective function. The objective function may be constructed based on an acquisition process of the image data. The objective function may include a fidelity term and a regularization term. The fidelity term may be related to an imaging physical model of the fluorescence microscopy. The regularization term is determined using a regularization network.

In some embodiments, a trained regularization network may be obtained by training an initial regularization network using a plurality of training samples. As shown in FIG. 20, an exemplary training process 2000 of the regularization network may include: obtaining a plurality of reference images 2010 with an illumination laser intensity higher than an intensity threshold and/or an exposure time longer than a time threshold, in which the plurality of reference images 2010 may be acquired by the fluorescence microscopy; obtaining a plurality of sample multi-dimensional images 2020 by superimposing one or more noises to the plurality of reference images 2010; and obtaining the regularization network by training the initial regularization network using the plurality of sample multi-dimensional images 2020 as the training samples and corresponding reference images 2010 as the labels. In some embodiments, the training samples may be input into the initial regularization network to obtain output images. In some embodiments, the parameters of the initial regularization network may be adjusted based on differences between the output images and the labels. For example, the value of a loss function may be determined based on the output images and the labels, and the parameters of the initial regularization network may be adjusted based on the value of the loss function. In some embodiments, the noise(s) may be related to the imaging physical model of the fluorescence microscopy. In some embodiments, the noise(s) may be Gaussian noise(s). By adding the one or more noises to the plurality of reference images 2010, the image signal-to-noise ratio may be reduced, and an image obtained under a relatively poor imaging condition may be simulated, so that the trained regularization network may have the capability of identifying and removing the noise(s) in the image(s), and at the same time, important features and details in the image(s) may be maintained.

In some embodiments, a reference image 2010 may be a gold standard image (or a GT image) of the observed object obtained by the fluorescence microscopy. The gold standard image may accurately reflect feature(s) of the observed object. However, in some embodiments, since the gold standard image may be acquired by the fluorescence microscopy under a relatively high illumination laser intensity and a relatively long exposure time, the relatively high illumination laser intensity and the relatively long exposure time may cause a morphological change of the observed object or apoptosis of cell(s), and therefore may be not used in a cell observation task in a common scenario. In the cell observation task for the common scenario, to ensure the activity of the cell(s), the images with the illumination laser intensity lower than the intensity threshold and the exposure time shorter than the time threshold may be used, but since the illumination laser intensity and the exposure time are relatively low, the image signal-to-noise ratio of the image with the illumination laser intensity lower than the intensity threshold and the shorter exposure time may also be significantly lower than that of the image signal-to-noise ratio of the foregoing gold standard image. In some embodiments of the present disclosure, a small portion of cell activity is sacrificed to obtain the reference image 2010 with a high signal-to-noise ratio as training data and is used to train the regularization network, such that the three-dimensional image obtained may have a relatively high signal-to-noise ratio by using a trained model in a same class of cell observation tasks (the cells are sacrificed).

It should be noted that if the same fluorescence microscopy is used in tests, for the same type of cell observation tasks, the reference images 2010 are merely obtained once and the training of the model can be performed. When other types of cells need to be observed, the training process 2000 of the regularization network described above may be re-executed using the reference images 2010 corresponding to the other types of cells to obtain the regularization network corresponding to the other types of cells.

In some embodiments, for a single reference image 2010, the plurality of sample multi-dimensional images 2020 may be obtained by superimposing different noises (e.g., with different noise distributions and/or different noise intensities, etc.) in the reference images 2010. The plurality of different sample 3D images 2020 may be quickly obtained by superimposing the one or more noises on the plurality of acquired reference images 2010.

In some embodiments, for a plurality of sample 3D images 2020, the corresponding reference images 2010 may be used as labels, i.e., the reference images 2010 of the sample 3D image 2020 before noise is added to the sample 3D image 2020 may be used as the label for the sample 3D image 2020, and the reference images 2010 with a higher signal-to-noise ratio and the sample 3D images 2020 with a lower signal-to-noise ratio may be used to form a sample pair with a high and a low signal-to-noise ratio respectively. In some embodiments, operations such as random cropping, rotating, and/or flipping may be performed on the training samples with labels to further expand the training samples.

In some embodiments, the training the initial regularization network using the plurality of sample multi-dimensional images as the training samples and the corresponding reference images as the labels may include: inputting a plurality of training samples with the labels into the initial regularization network, constructing a loss function through the labels and result images 2030 output by the initial regularization network after the plurality of iterations, iteratively updating the parameters of the initial regularization network through gradient descent or other process based on the loss function, and accomplishing the model training in response to that the preset conditions are satisfied, and obtaining the trained regularization network. The preset conditions may include a convergence of the loss function, the count of iterations reaching a threshold, etc.

In some embodiments, the parameters of the updated initial regularization network may include at least weight parameters of the multi-scale convolutional neural network. In some embodiments, the weight parameters of the multi-scale convolutional neural network may be updated using an error back propagation algorithm. The present disclosure does not impose any limitation on the model training process.

### EXAMPLES

### Example 1—Selection of Parameters λ and T

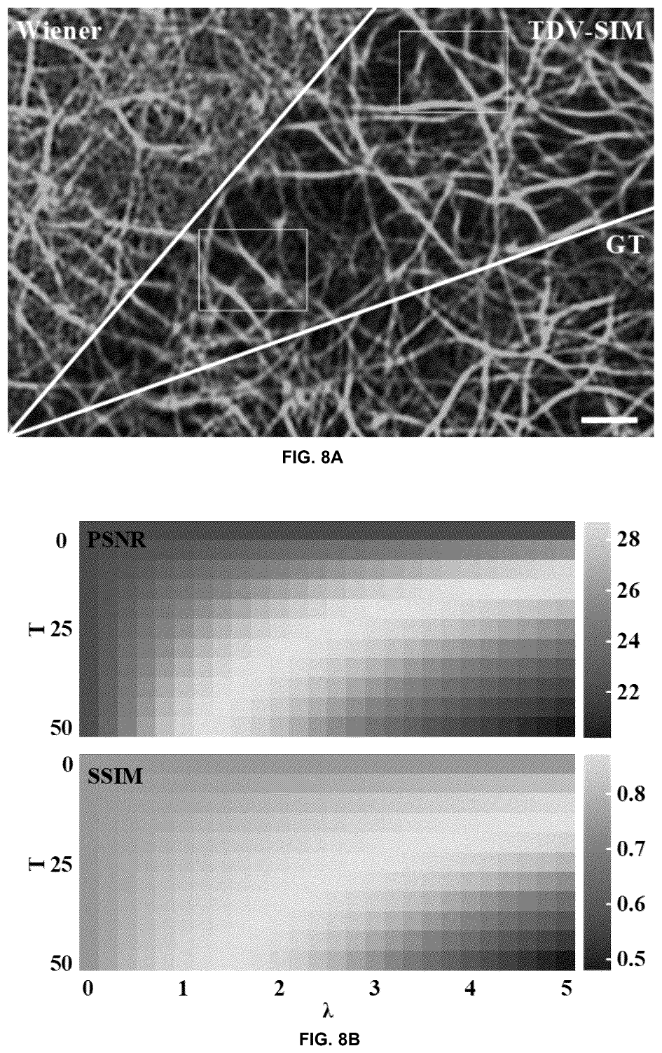

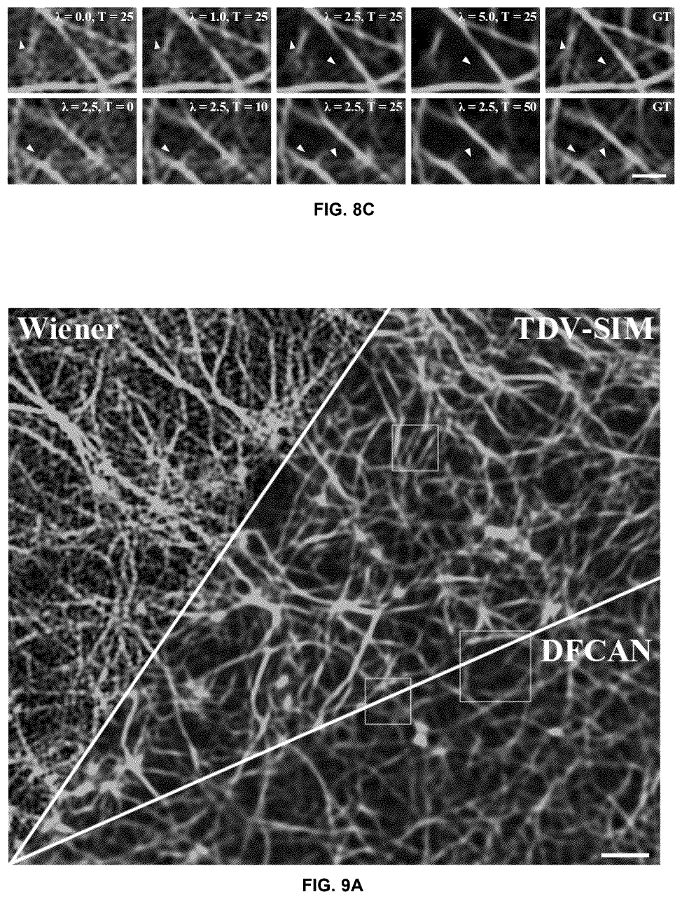

FIG. 8A-8C shows the effect of some parameters on the target image according to some embodiments of the present disclosure. As described earlier, the values of λ and T may affect the image quality of the target image. FIG. 8A shows a reference image using the conventional Wiener reconstruction method, a target image using the image processing model provided by the present disclosure, and the ground truth (GT) image. For illustration purposes, the image processing model provided by the present disclosure may be applied to the reconstruction of an SIM image, and the second sub-model of the image processing model may be based on TDV regulation. Accordingly, the image processing model may be referred to as “TDV-SIM”. FIG. 8B shows the Peak Signal-to-Noise Ratio (PSNR) and Structural Similarity (SSIM) of the target image and GT when changing λ and T. FIG. 8C shows images of portions marked by the gray boxes in FIG. 8A, which respectively corresponds to a target image reconstructed using the image processing model provided by the present disclosure based on the same image data using different values of λ and T. Compared to the GT image of actin filaments (averages of multiple Wiener-processed images, FIG. 8A), the peak signal-to-noise (PSNR, FIG. 8B) and structural similarity index measure (SSIM, FIG. 1d, top right) values of TDV-SIM reconstructions with different weight parameter λ and iteration number T were quantified. As shown in FIG. 8C, artifacts may not be suppressed entirely if λ (or T) is too small; in contrast, if λ (or T) is too large with a fixed T of 25 (or a λ of 2.5), genuine signals may be removed incorrectly. Thus, the optimal parameters in this example was set to be 2.5 and 25 for λ and T, respectively. These results indicate that the selection of the values of λ and T may affect the image quality of the obtained target image.

In some embodiments, the processor may firstly generate a target image based on default values of λ and T. After the target image is presented to the user, the user may evaluate the image quality of the target image. If the user determines that the image quality is not satisfying enough (e.g., there is still some noise in the target image), the user may manually adjust the value(s) of λ and/or T. Alternatively, the processor 140 may generate multiple target images according to the multiple value sets for λ and T. These target images may be presented to the user and the user may select one of the target images with the highest image quality for further observation or analysis.

### Example 2-TDV-SIM May Improve the Image Quality of an Image Reconstructed Based on Image Data With a Relatively Low Signal-Noise Ratio

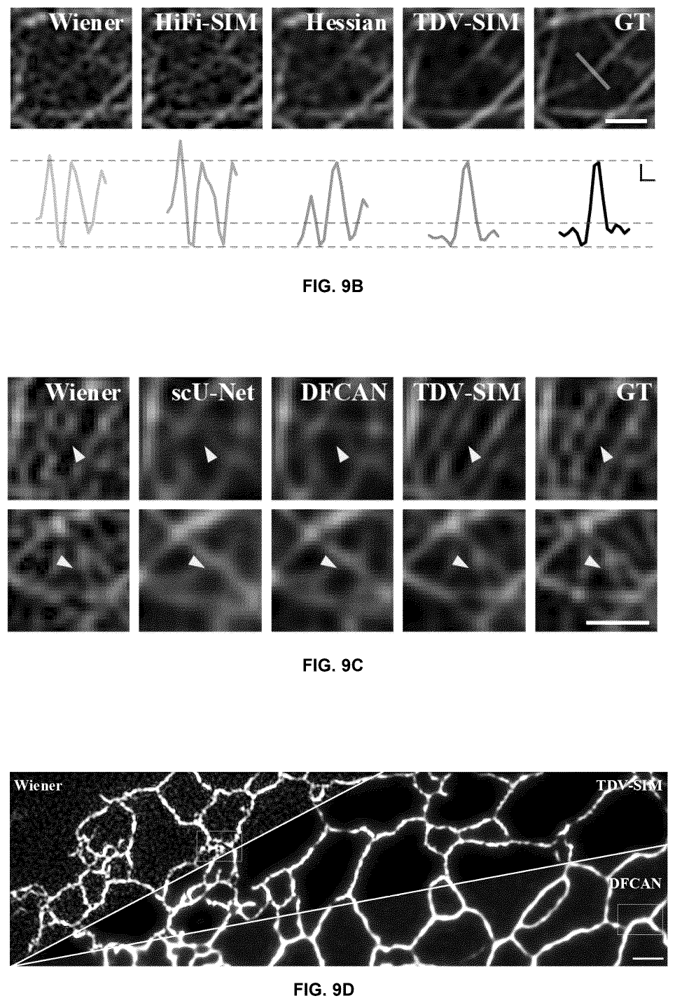

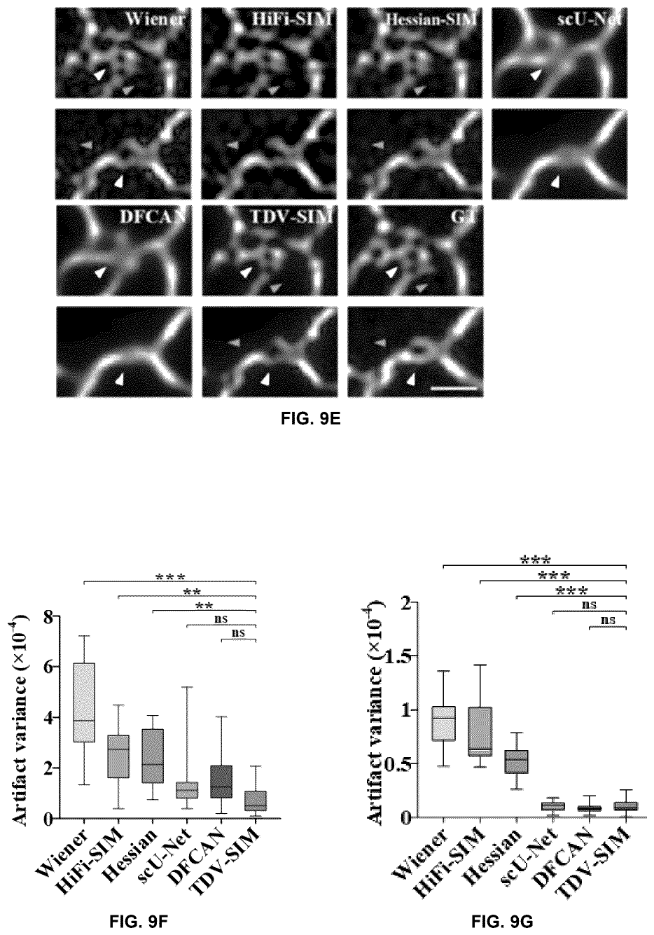

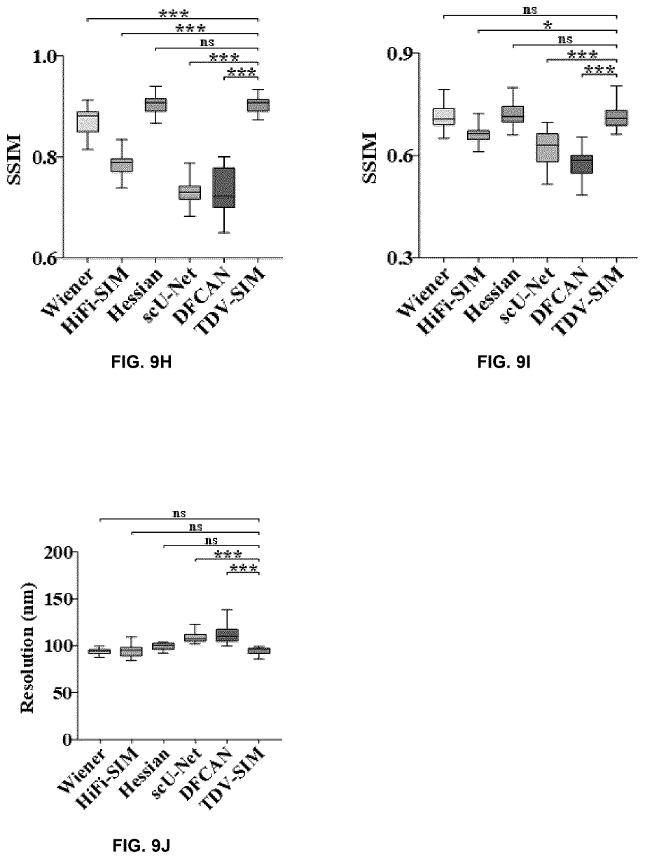

For illustration purposes, TDV-SIM was compared with other reconstruction methods, including physical-model-based (Wiener deconvolution11, HiFi-SIM, Hessian-SIM) and pure deep learning-based methods (scU-Net, DFCAN) using synthetic images with known GT. The results are shown in FIGS. 9A-9E. FIG. 9F shows artifact variances of actin filaments from background regions in different reconstructions. FIG. 9G shows artifact variances of ER tubules from background regions in different reconstructions. FIG. 9H shows SSIM of actin filaments in different reconstructions. FIG. 9I shows SSIM of ER tubules in different reconstructions. FIG. 9J shows resolutions of different reconstructions of actin filaments in FIGS. 9A-9C.

TDV-SIM confers balanced performance in generating SR images of high SSIM, low normalized root-mean-square error, and low artifacts among all reconstruction methods. Next, dynamic actin filaments and ER in live cells were observed with short exposures (actin: 1 ms, FIG. 9A; ER: 0.789 ms, FIG. 9D). Despite the improved reconstructions compared to the Wiener deconvolution, HiFi-SIM and Hessian-SIM still produced artifacts due to noise amplification in background regions with low SNR. TDV-SIM produced more continuous actin filaments with fewer artifacts but comparable SSIM values and resolutions to the conventional reconstruction methods (FIG. 9B, E, F-J). In contrast, pure DL-based methods led to reconstruction with fewer artifacts at the price of reduced resolution and decreased SSIM values. In addition, inaccurate inferences were often observed at the intersections of actin filaments and ER (the white (bright) arrows in FIG. 9C and FIG. 9E). The gray (darker) arrows in FIG. 9E highlights the artifacts of physical-model-based methods.

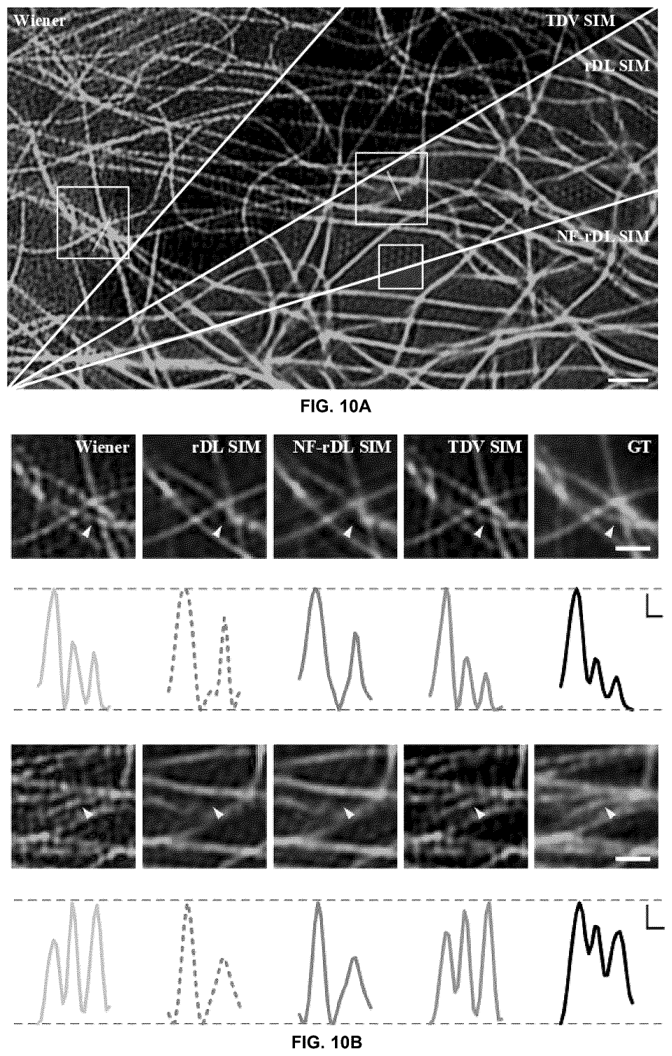

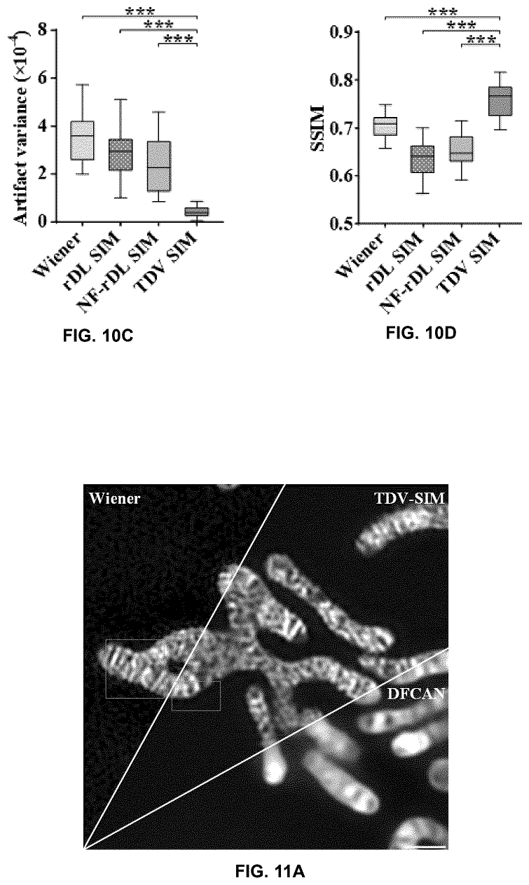

Furthermore, TDV SIM was compared with rDL SIM on a microtubule image from the BioSR dataset (FIGS. 10A-10D). By incorporating prior knowledge of illumination patterns into the DL network, rDL SIM aimed to denoise raw images rationally. Still, it produced punctated artifacts in background regions, which may be suppressed with a notch filter (NF) (white boxed region in FIG. 10A, FIG. 10C). Moreover, microtubules within densely-labeled regions were often absent from notch-filtered rDL SIM reconstructions (NF-rDL SIM, arrows in FIG. 10B), which was confirmed by the missing spikes in corresponding fluorescence profiles in the bottom. In comparison, TDV-SIM can avoid the missing signal problem of notch-filtered rDL SIM and produce higher fidelity reconstructions with fewer artifacts and higher SSIM (FIGS. 10A-10D).

These results indicate that the TDV-SIM method provided by the present disclosure may improve the image quality of an image including regular cell structures that is reconstructed based on image data with a relatively low signal-noise ratio.

### Example 3-TDV-SIM may Improve the Accuracy of Reconstruction of Intricate and Dynamic Mitochondrial Cristae Structures in Live Cells after Prolonged Bleaching

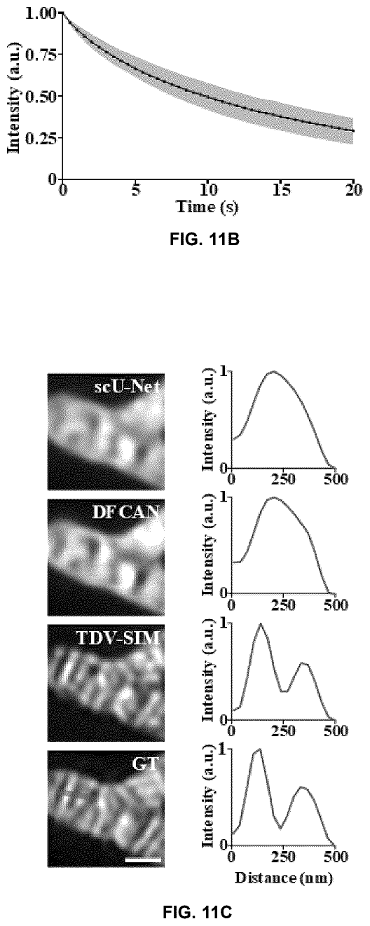

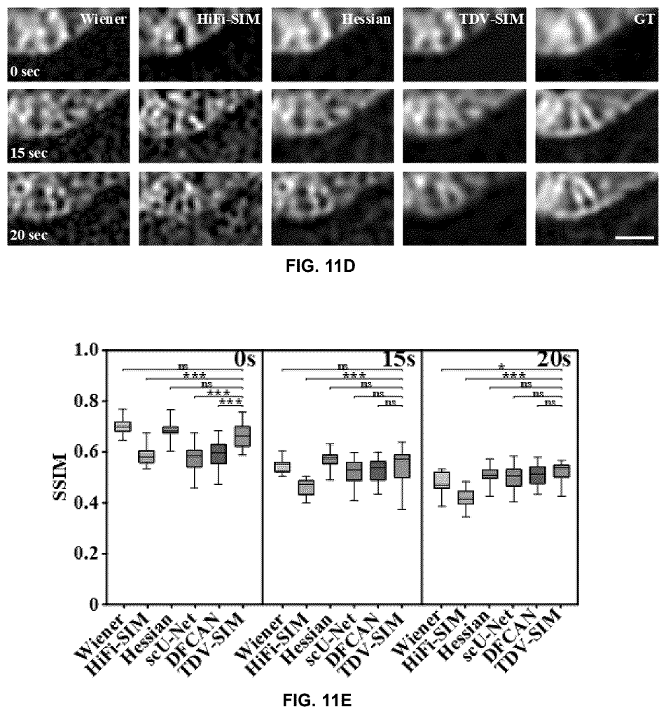

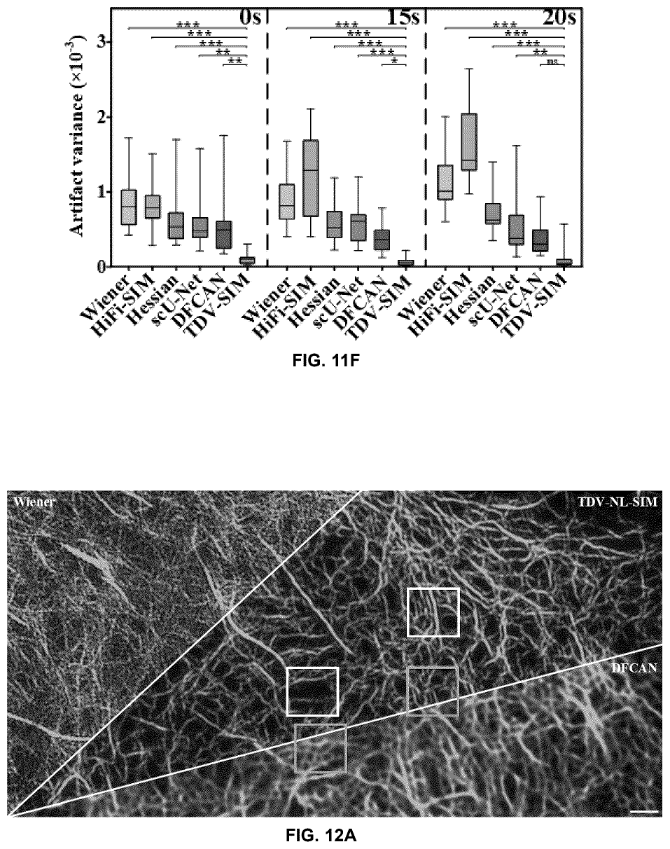

Photobleaching constitutes a major problem of fluorescence SR imaging, continuously reducing image SNR and compromising the quality of reconstructed images, especially upon resolving nonstereotypical structures such as mitochondrial cristae30. Therefore, the performance of TDV-SIM in resolving mitochondrial cristae dynamics for a prolonged time in live cells was benchmarked (FIG. 11A). During the 20 s recording, the fluorescence intensity of Mito-Tracker decreased by ˜30% due to photobleaching (FIG. 11B). In the beginning, model-based methods could reconstruct high-quality intricate mitochondrial cristae, which were gradually corrupted with artifacts gradually due to photobleaching (FIGS. 11D and F). In contrast, although pure DL-based methods consistently generated fewer artifacts during the imaging period, they could not predict most cristae structures in the first place (FIGS. 11C, 11E, and 11F). Outperforming all other methods, TDV-SIM obtained sharp mitochondrial cristae structures with fewer artifacts and high SSIM with the GT, which persisted even under photobleaching conditions (FIGS. 11C-11F).

### Example 4-TDV-SIM Enables Better Reconstruction of Actin Filaments Under Nonlinear SIM

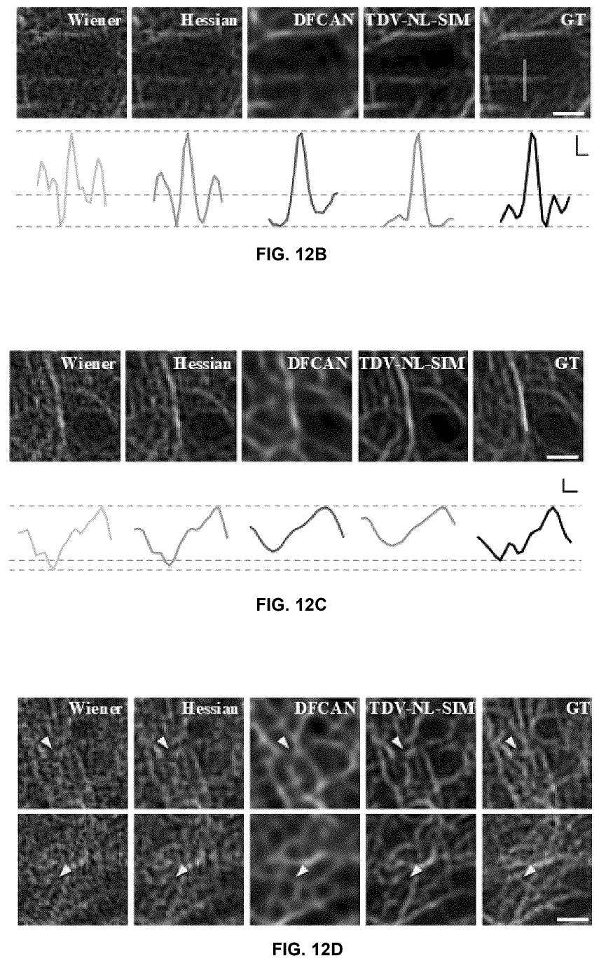

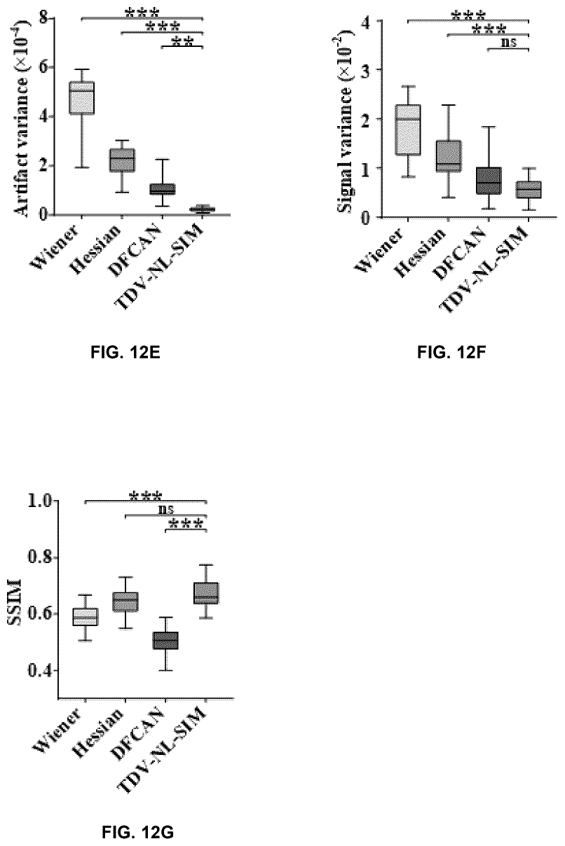

In comparison to conventional linear SIM, nonlinear (NL) SIM achieves higher lateral resolution up to ˜60 nm. While, NL-SIM suffers from the reconstruction artifacts especially with low SNR raw data. By combining the NL-SIM physical model with the TDV regularization term, the TDV-NL-SIM was proposed. The performance of TDV-NL-SIM was benchmarked with Wiener deconvolution, Hessian-NL-SIM, and DFCAN on actin filaments within the BioSR dataset (FIG. 12A). Similar to the linear SIM circumstances, Hessian-NL-SIM provided improved reconstructions than Wiener deconvolution but still produced significant artifacts in background regions. In contrast, TDV-NL-SIM produced more continuous actin filaments (FIGS. 12C and 12F) with fewer artifacts but comparable SSIM values to Hessian-NL-SIM (FIGS. 12B, 12E, and 12G). DFCAN led to reconstruction with comparable continuity but decreased SSIM values to TDV-NL-SIM (FIGS. 12F and 12G). The inaccurate inferences of DFCAN at the actin filaments intersections can be avoided by the TDV-NL-SIM (arrows in FIG. 11D).

These results indicate that the image processing model provided by the present disclosure may effectively reduce artifacts or noise of the reconstructed image generated based on raw images with relatively low signal-noise ratio due to, e.g., photobleaching.

The image processing model provided by the present disclosure combines the constrain of the imaging principle as well as the use of the deep learning network, thereby effectively improving the image quality of the reconstructed image generated based on image data collected by the image acquisition device. The use of the deep learning network contributes to reducing artifacts or noise in the target image. Moreover, the use of the likelihood term ensures that the reconstruction is based on the imaging principle, thus reducing or avoiding errors in the reconstructed image.

### Example 5-Comparison of TDV 3D-SIM and State-of-the-Art 3D-SIM Methods

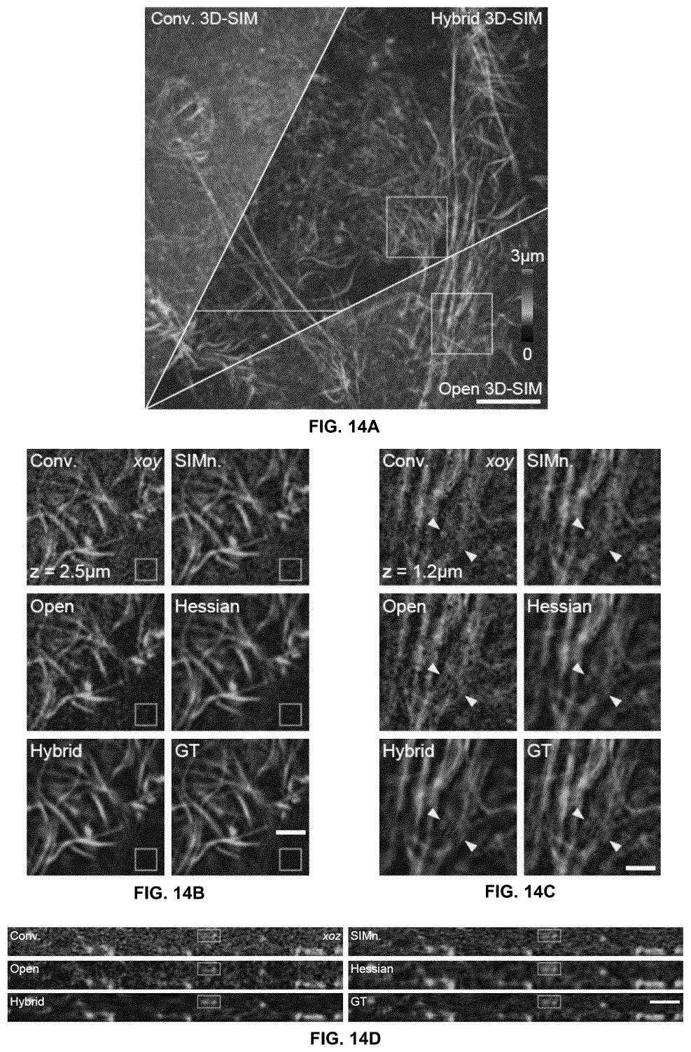

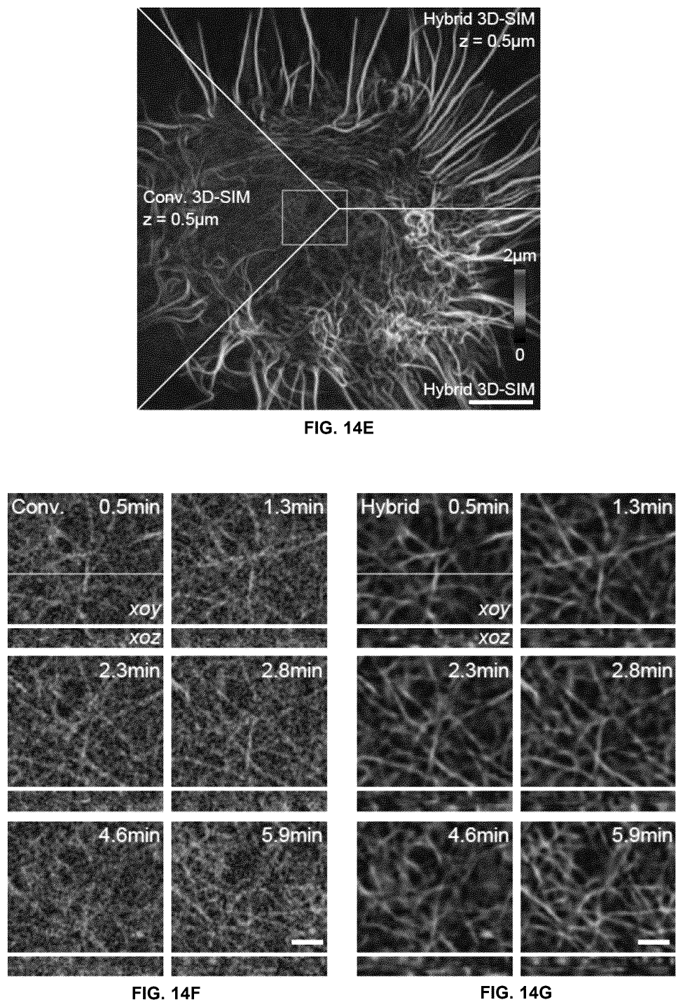

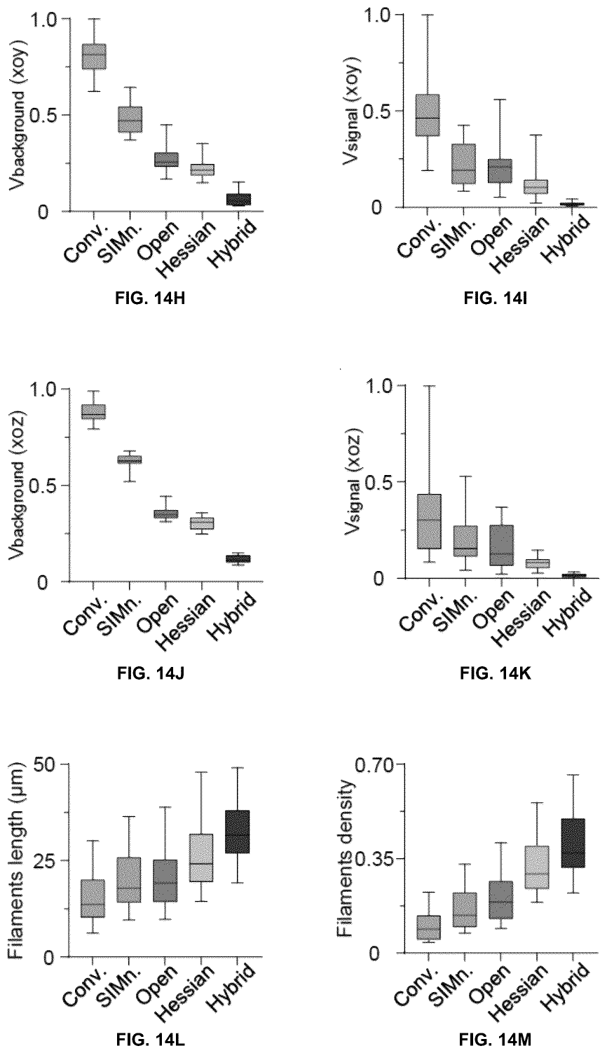

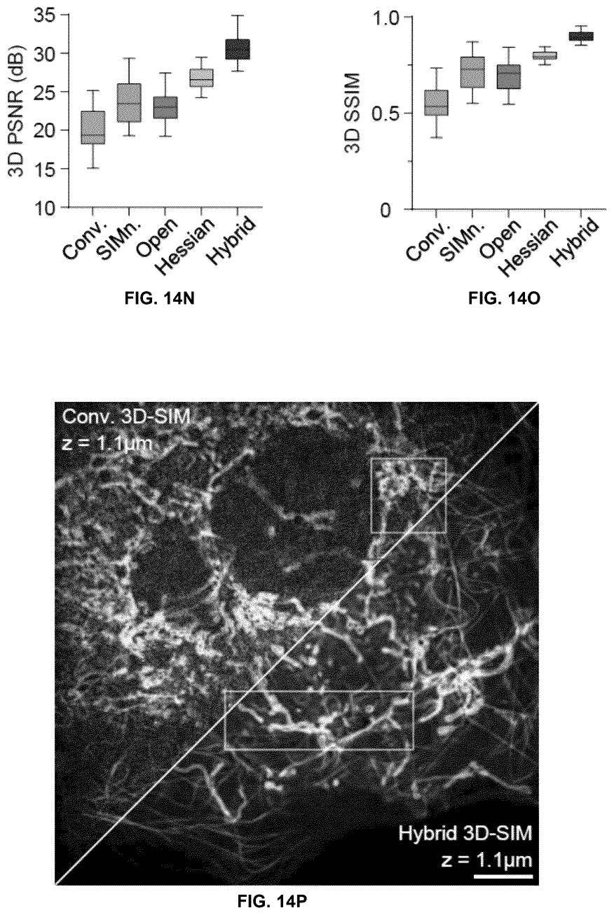

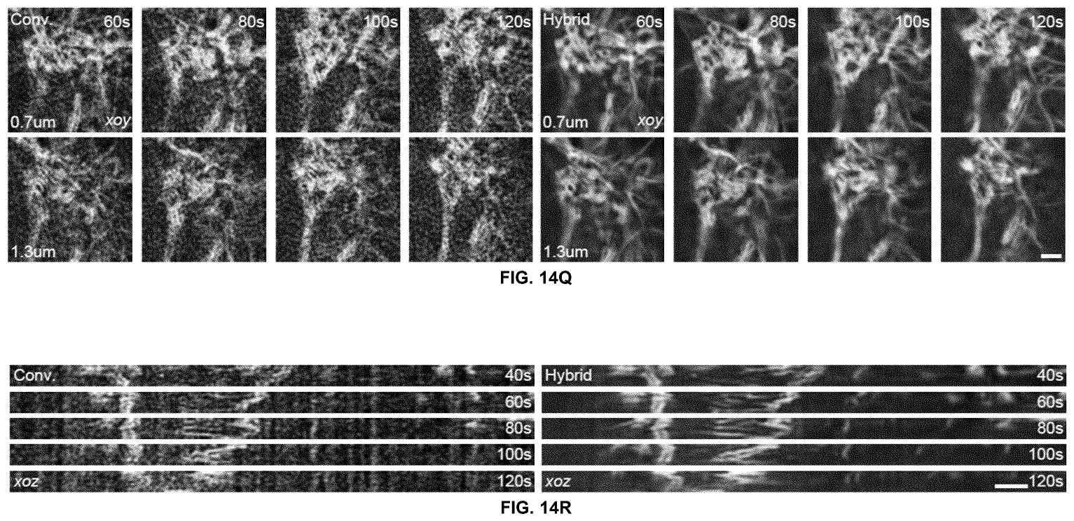

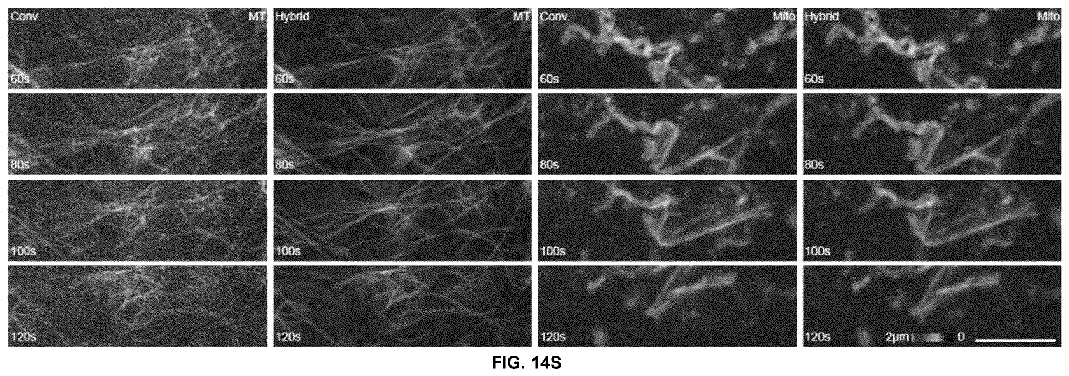

The TDV restoration method was integrated into 3D-SIM (TDV 3D-SIM) and a systematic evaluation of TDV 3D-SIM and other state-of-the-art 3D-SIM methods was performed, including SIMnoise, Open 3D-SIM and Hessian 3D-SIM on F-actin filaments (FIGS. 14A-14S). For background regions with low SNR, SIMnoise, Open 3D-SIM and Hessian 3D-SIM still produced artifacts due to noise amplification despite the improved reconstructions compared to the conventional 3D-SIM (FIG. 14B). As a comparison, TDV 3D-SIM produced more continuous (FIGS. 14C, 14I, 14M) and complete structures (FIGS. 14C, 14D, 14J, 14K) with fewer artifacts (FIGS. 14B, 14D, 14H, 14L) and higher resolution maintenance (FIGS. 14C, 14D), 3D PSNR (FIG. 14N) and 3D SSIM (FIG. 14O) than other methods. The volumetric SR imaging capability of TDV 3D-SIM and conventional 3D-SIM was further assessed with live COS-7 cell specimens expressing Lifeact-EGFP (FIG. 14E). TDV 3D-SIM clearly super-resolved the intricate 3D structures of actin filaments which were distorted severely by the artifacts within the conventional 3D-SIM reconstructions (FIGS. 14F, 14G).

Next, the TDV 3D-SIM was applied to live COS-7 cell specimens co-expressing MitoTracker and SiR-Tublin, for visualizing the structure dynamics and interactions of microtubule and mitochondria (FIGS. 14P-14S). Although the wide-field epi-illumination configuration used in 3D-SIM results in a rapid photobleaching, TDV 3D-SIM can consistently produce high-quality time-lapse volumetric SR images of microtubule. In contrast, conventional 3D-SIM produced uninterpretable SR images under the same conditions. For mitochondria channel with relatively higher SNR, conventional 3D-SIM could produce perceptually good SR images but still degraded by the reconstruction artifacts within the background regions. And these artifacts could be totally eliminated by TDV 3D-SIM. Taken together, these results illustrate the superior volumetric SR imaging capability of TDV 3D-SIM, promoting the volumetric SR imaging of light-sensitive bioprocesses with minimal invasiveness.

FIGS. 14A-14S illustrate an exemplary comparison result of TDV 3D-SIM with state-of-the-art 3D-SIM methods according to some embodiments of the present disclosure. FIG. 14A shows representative 3D-SIM image of F-actin reconstructed by conventional 3D-SIM, Open 3D-SIM and TDV 3D-SIM, color-coded for distance from the substrate. FIGS. 14B-14D show magnified xoy views of the boxed regions and xoz views along the line (FIG. 14D) in (FIG. 14A) reconstructed by conventional 3D-SIM, SIMnoise, Open 3D-SIM, Hessian 3D-SIM and TDV 3D-SIM. GT 3D-SIM images acquired at high SNR are shown for reference. FIG. 14E shows representative 3D-SIM image of F-actin within a live COS-7 cell expressing Lifeact-EGFP reconstructed by conventional 3D-SIM and TDV 3D-SIM, color-coded for distance from the substrate. FIGS. 14F-14G show time-lapse magnified xoy views of the boxed regions in (FIG. 14E) reconstructed by conventional 3D-SIM (FIG. 14F) and TDV 3D-SIM (FIG. 14G). The xoz views along the lines are on the bottom. FIGS. 14H-14I show background (FIG. 14H) and signal (FIG. 14I) variances of xoy planes in different reconstructions (n=20). FIGS. 14J-14K show background (FIG. 14J) and signal (FIG. 14K) variances of xoz planes in different reconstructions (n=20). FIGS. 14L-14M show length of actin filaments (FIG. 14L) after segmentation and skeletonization (n=16) and density of filaments (FIG. 14M) after segmentation (n=16). FIGS. 14N-14O show 3D PSNR (FIG. 14N) and 3D SSIM (FIG. 14O) of different reconstructions (n=20). FIG. 14P shows representative 3D-SIM image of microtubule and mitochondria reconstructed by conventional 3D-SIM and TDV 3D-SIM. FIG. 14Q shows time-lapse xoy views of different imaging depths within the white square boxed regions in (FIG. 14A) reconstructed by conventional 3D-SIM (left columns) and TDV 3D-SIM (right columns). FIG. 14R show time-lapse magnified xoz views along the line in (FIG. 14A) reconstructed by conventional 3D-SIM (left column) and TDV 3D-SIM (right column). FIG. 14S shows time-lapse magnified views of microtubule (MT) and mitochondria (Mito) within the white rectangular boxed regions in (FIG. 14P) reconstructed by conventional 3D-SIM (left columns) and TDV 3D-SIM (right columns), color-coded for distance from the substrate. Scale bars, 5 μm (FIGS. 14A, 14E, 14P, 14S) and 1 μm (FIGS. 14B, 14C, 14D, 14F, 14G, 14Q, 14R).

### Example 6-High-Fidelity 2D/3D Time-Lapse Imaging with TDV CSDM

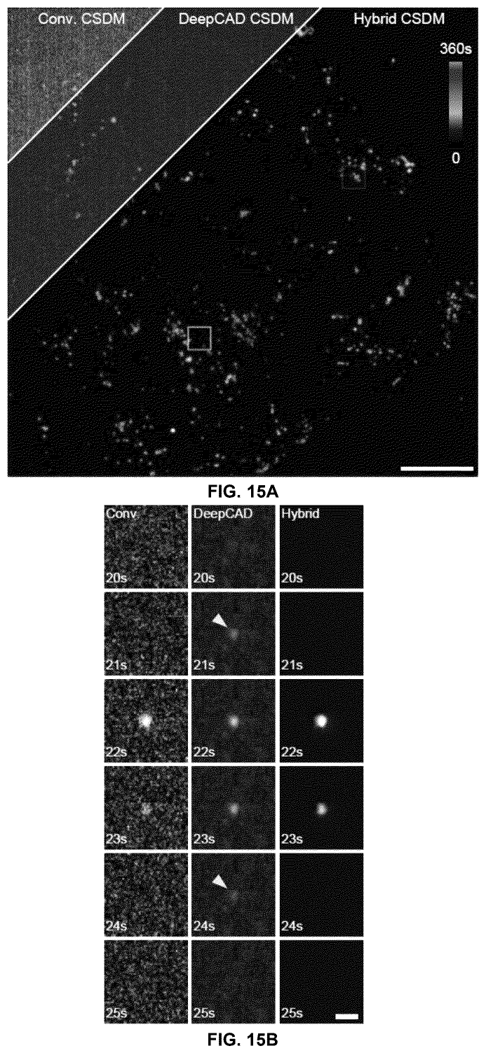

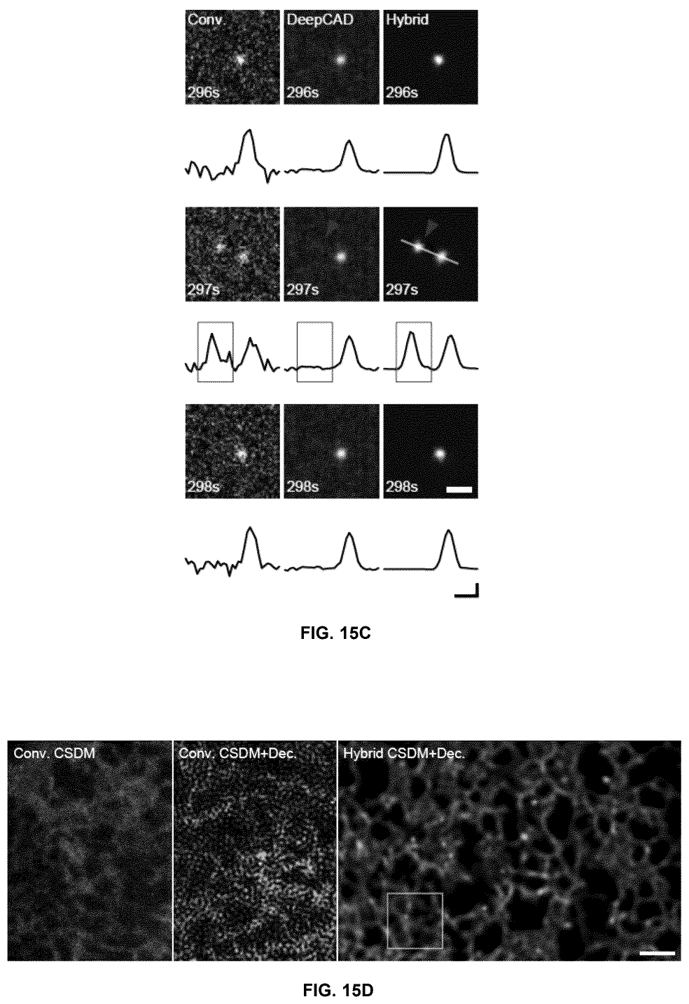

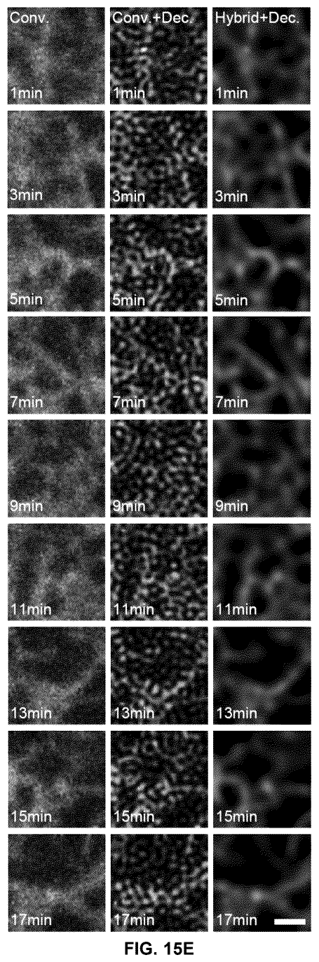

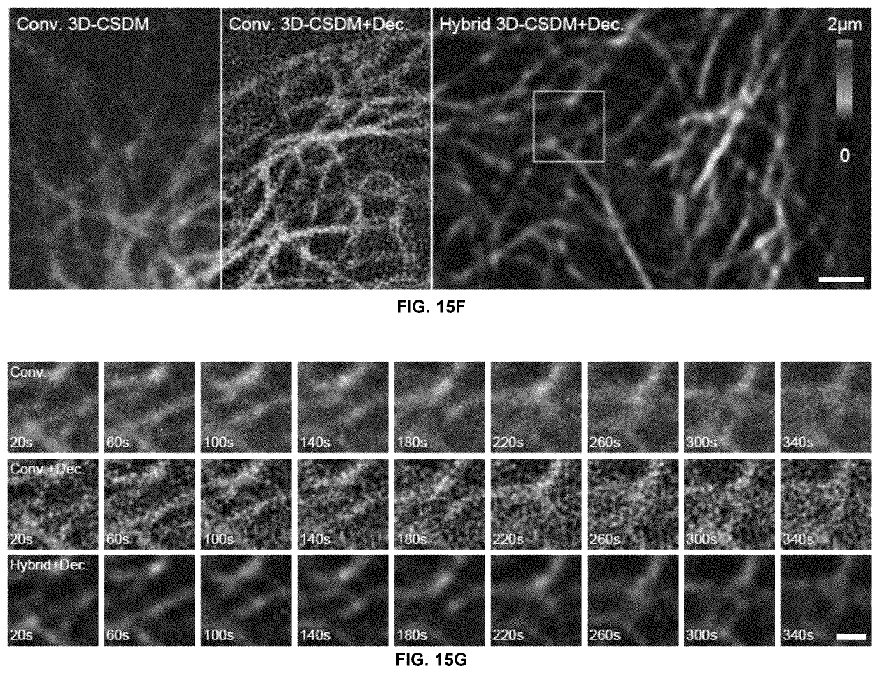

For validating the versatility of TDV restoration for fluorescence microscopy, the TDV restoration strategy was integrated into CSDM (TDV CSDM). The restoration performance of TDV CSDM was demonstrated on time-lapse islet zinc ions secretion images (FIGS. 15A-15C) after training with synthetic hyper-realistic imaging data by modeling zinc ions secretion events with specific fluorescence imaging models. For raw images severely contaminated by noise with conventional CSDM, DeepCAD-CSDM inferred decent de-noised images but existed signal temporal leakage (FIG. 15B, arrows) and missing (FIG. 15C, arrows and boxes) which can be totally avoided by TDV CSDM.

Then, the TDV CSDM was applied to live COS-7 cell specimens co-expressing EGFP-KDEL and PEX2-GFP, for capturing the continuous time-lapse images of endoplasmic reticulum and peroxisome (FIGS. 15D, 15E). Due to the low SNR, conventional CSDM images even after deconvolution hardly convey usable information. As a comparison, TDV CSDM provided higher SNR and higher contrast images after appending with the deconvolution. And the high-fidelity performance benefit of TDV restoration can be maintained in 3D-CSDM volumetric time-lapse imaging of microtubule (FIGS. 15F, 15G).

FIGS. 15A-15G illustrate TDV restoration improves CSDM imaging without signal temporal leakage and missing according to some embodiments of the present disclosure. FIG. 15A shows representative CSDM image of islet zinc ions secretion by conventional CSDM, DeepCAD CSDM and TDV CSDM, color-coded for time from the imaging beginning. FIGS. 15B-15C show time-lapse magnified views within the boxed regions in (FIG. 15A) by conventional CSDM, DeepCAD CSDM and TDV CSDM. The profiles along the white line in (FIG. 15C) are on the bottom. FIG. 15D shows representative CSDM image of endoplasmic reticulum and peroxisome by conventional CSDM, conventional CSDM after deconvolution and TDV CSDM after deconvolution. FIG. 15E shows time-lapse magnified views within the square boxed regions in (FIG. 15D) by conventional CSDM, conventional CSDM after deconvolution and TDV CSDM after deconvolution. FIG. 15F shows representative 3D-CSDM image of microtubule by conventional 3D-CSDM, conventional 3D-CSDM after deconvolution and TDV 3D-CSDM after deconvolution, color-coded for distance from the substrate. FIG. 15G shows time-lapse magnified views within the white square boxed regions in (FIG. 15F) by conventional 3D-CSDM, conventional 3D-CSDM after deconvolution and TDV 3D-CSDM after deconvolution. Scale bars, 5 μm (FIG. 15A), 2 μm (FIGS. 15D, 15F), 1 μm (FIGS. 15B, 15C, 15E, 15G), 0.5 μm (FIG. 15C, profile, horizontal axis) and 0.2 a.u. (FIG. 15C, profile, vertical axis).

### Example 7-Long-Term Volumetric Imaging with TDV FLFM

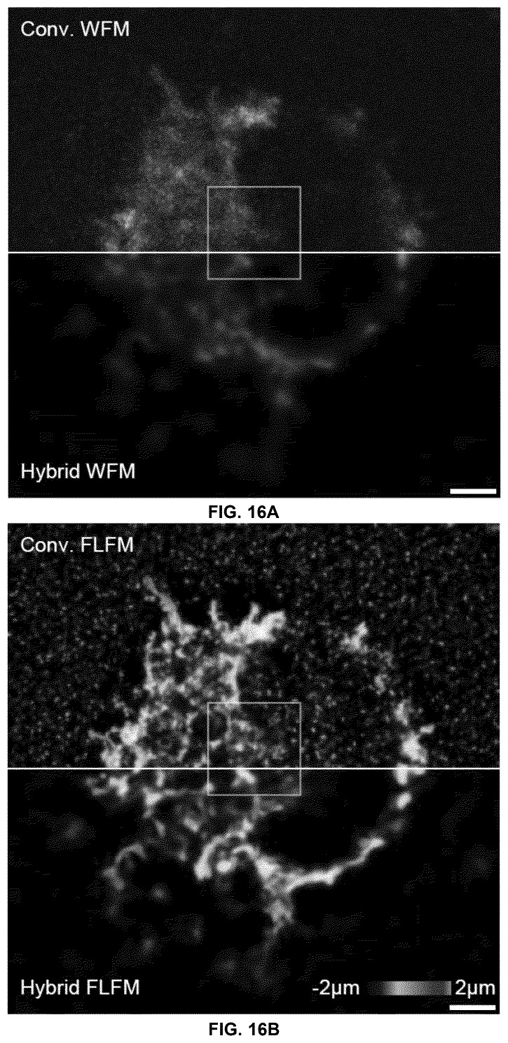

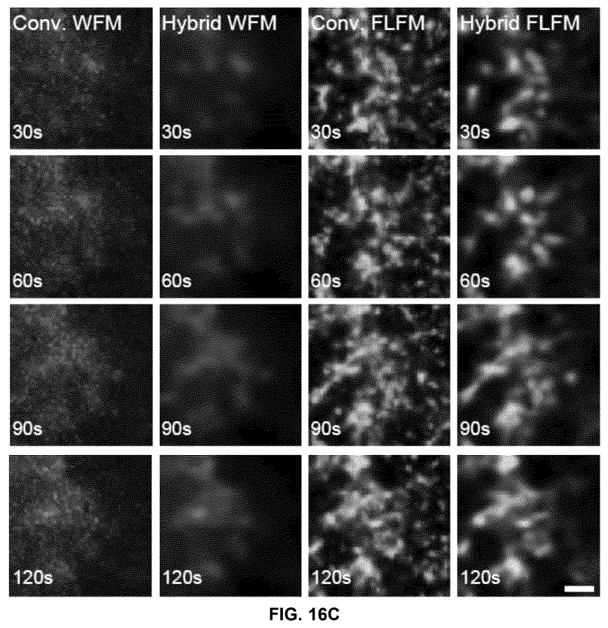

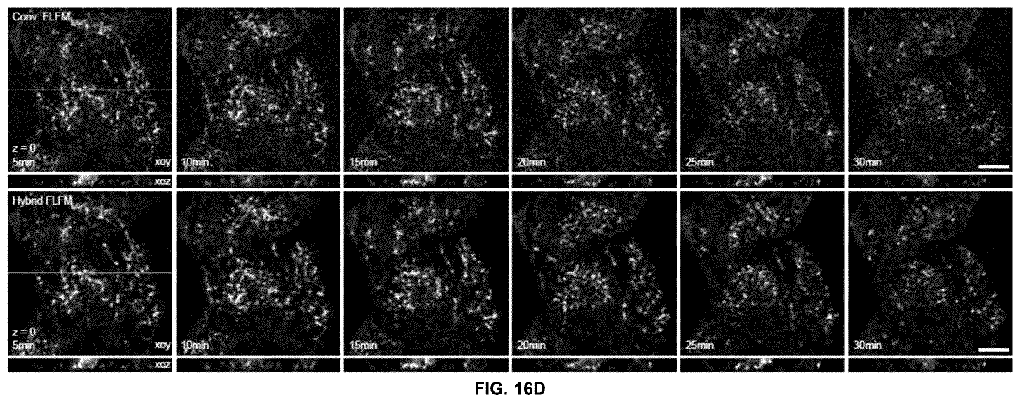

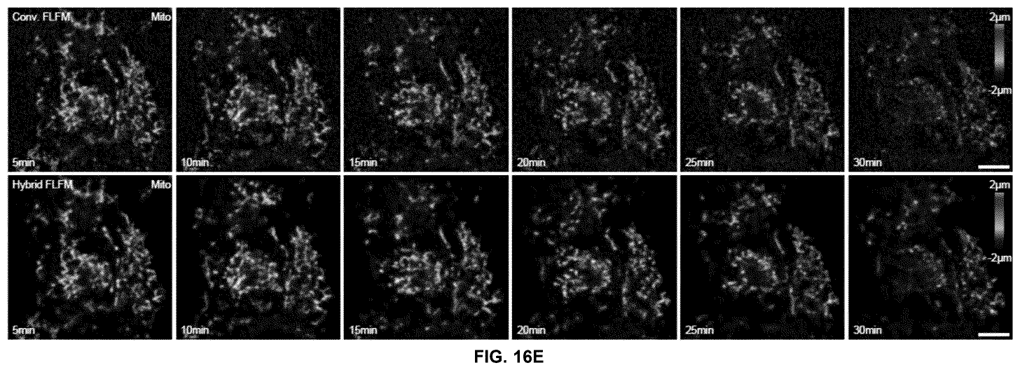

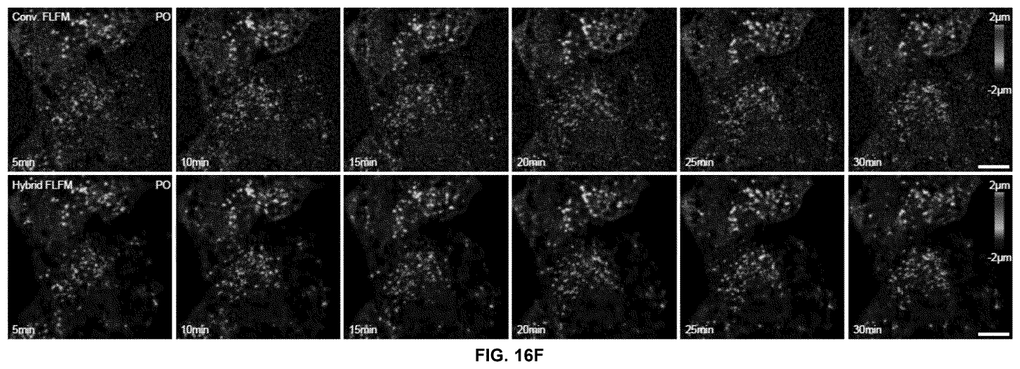

The versatility of TDV restoration was further demonstrated on the FLFM. Conventional FLFM enables fast, volumetric and multicolor live-cell imaging, but the imaging duration is limited by the wide-field epi-illumination configuration induced photobleaching. To address the limitations of epi-illumination while retaining the volumetric imaging capability, TDV restoration was implemented into a home-built FLFM platform to develop the TDV FLFM system (FIGS. 16A-16F).

The FLFM raw images were acquired by the wide-field epi-illumination configuration and can be treated as the wide-field microscopy (WFM) images. And the sample volumetric distribution can be reconstructed by the 3D deconvolution. For the 3D reconstruction of low SNR FLFM raw images, the noise is amplified by the deconvolution and transferred into the artifacts. The noise and artifacts within the conventional time-lapse WFM planar images and FLFM volumetric reconstructions can be totally eliminated by the TDV restoration (FIGS. 16A-16C).

Then, the TDV FLFM was applied to live COS-7 cell specimens co-expressing MitoTracker and PEX2-mcherry, for prolonged visualizing the volumetric structural and dynamic information of mitochondria and peroxisome (FIGS. 16D-16F). During the 30 minutes recording, the conventional FLFM 3D reconstructed volumes were continuously degraded by severe artifacts and the structural dynamic information was almost completely invisible, especially for the peroxisome channel due to the high similarity of sample structure and artifacts distribution. And TDV FLFM confers balanced performance in providing volumetric reconstructions of low artifacts while preserving the fine subcellular structures. In brief, TDV restoration extended the imaging duration of WFM planar and FLFM volumetric imaging as a generic method.

FIGS. 16A-16F illustrate TDV restoration improves live-cell dual-color time-lapse WFM and FLFM imaging of mitochondria and peroxisomes according to some embodiments of the present disclosure. FIGS. 16A-16B show representative WFM (FIG. 16A) and FLFM (FIG. 16B) image of mitochondria by conventional WFM, TDV WFM, conventional FLFM and TDV FLFM, color-coded for distance from the focal plane in (FIG. 16B). FIG. 16C shows time-lapse magnified views within the boxed regions in (FIG. 16A) and (FIG. 16B) by conventional WFM, TDV WFM, conventional FLFM and TDV FLFM. FIGS. 16D-16F show live-cell long-term dual-color FLFM imaging of mitochondria (FIG. 16D, magenta and FIG. 16E, Mito) and peroxisomes (FIG. 16D, green and FIG. 16F, PO) by conventional FLFM (top rows) and TDV FLFM (bottom rows). The xoz views along the lines in (FIG. 16D) are on the bottom. Color-coded for distance from the focal plane in (FIG. 16E) and (FIG. 16F). Scale bars, 5 μm (FIGS. 16A, 16B), 2 μm (FIG. 16C) and 10 μm (FIGS. 16D, 16E, 16F).

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended for those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or characteristics may be combined as suitable in one or more embodiments of the present disclosure.

Further, it will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.), or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1-21. (canceled)

22. A method for image processing implemented on a computing device having one or more processors and one or more storage devices, comprising:
obtaining multi-dimensional image data, wherein the multi-dimensional image data is generated by a fluorescence microscopy;
generating an initial multi-dimensional image based on the multi-dimensional image data; and
constructing an objective function based on an acquisition process of the multi-dimensional image data, and generating a target image by performing one or more iterations on the initial multi-dimensional image according to the objective function;
wherein:
the objective function includes a fidelity term and a regularization term,
the fidelity term is related to an imaging physical model of the fluorescence microscopy, and
the regularization term is determined using a regularization network.

23. The method of claim 22, wherein:
the regularization network includes a multi-scale convolutional neural network; and
the multi-scale convolutional neural network includes convolutional kernels with different receptive fields, and the convolutional kernels with different receptive fields are configured to extract features between a plurality of layers of the initial multi-dimensional image.

24. The method of claim 22, wherein the fidelity term is related to a conventional restoration image, and the conventional restoration image is determined based on the imaging physical model of the fluorescence microscopy.

25. The method of claim 24, a current iteration of the one or more iterations includes:
determining a partial derivative of the fidelity term based on the conventional restoration image and an output image of a previous iteration of the current iteration;
determining a partial derivative of the regularization term based on the output image of the previous iteration; and
determining an output image of the current iteration based on the partial derivative of the fidelity term, the partial derivative of the regularization term, and the output image of the previous iteration.

26. The method of claim 25, wherein the determining a partial derivative of the regularization term includes:
determining the conventional restoration image based on the imaging physical model of the fluorescence microscopy; and
determining the partial derivative of the fidelity term based on the conventional restoration image, the output image of the previous iteration and a preset relationship between the partial derivative of the fidelity term, the conventional restoration image, and the output image of the previous iteration;
wherein
the preset relationship is related to a noise of the imaging physical model of the fluorescence microscopy.

27. The method of claim 25, wherein the determining the partial derivative of the regularization term based on the output image of the previous iteration includes:
reversing the regularization network to obtain a reversed regularization network; and
determining the partial derivative of the regularization term based on the reversed regularization network.

28. The method of claim 27, wherein the reversing the regularization network includes:
transforming a convolutional layer of the regularization network into a transpose convolutional layer with a same convolutional kernel;
transforming an activation function of the regularization network into a gradient of the activation function;
transforming a potential function of the regularization network into a gradient of the potential function; and
transforming one or more blocks of the regularization network into one or more transpose blocks.

29. The method of claim 22, the regularization network is obtained according to a training process including:
obtaining a plurality of reference images with an illumination laser intensity higher than an intensity threshold and an exposure time longer than a time threshold, the plurality of reference images being acquired by the fluorescence microscopy;
obtaining a plurality of sample multi-dimensional images by superimposing one or more noises to the plurality of reference images; and
obtaining the regularization network by training an initial regularization network using the plurality of sample multi-dimensional images as training samples and corresponding reference images as labels, including:
inputting the training samples into the initial regularization network to obtain output images;
adjusting parameters of the initial regularization network based on differences between the output images and the labels.

30. The method of claim 22, wherein the fluorescence microscopy includes at least one of a structured illumination microscopy, a confocal spinning disk microscopy, a wide field microscopy, or a Fourier light field microscopy.

31. A system for image processing, comprising:
at least one storage device including a set of instructions; and
at least one processor in communication with the at least one storage device, wherein when executing the set of instructions, the at least one processor is directed to cause the system to perform operations including:
obtaining multi-dimensional image data, wherein the multi-dimensional image data is generated by a fluorescence microscopy;
generating an initial multi-dimensional image based on the multi-dimensional image data; and
constructing an objective function based on an acquisition process of the multi-dimensional image data, and generating a target image by performing one or more iterations on the initial multi-dimensional image according to the objective function;
wherein:
the objective function includes a fidelity term and a regularization term,
the fidelity term is related to an imaging physical model of the fluorescence microscopy, and
the regularization term is determined using a regularization network.

32-33. (canceled)

34. A method for image processing implemented on a computing device having one or more processors and one or more storage devices, comprising:
obtaining image data, wherein the image data is generated by a fluorescence microscopy;
generating an initial image based on the image data; and
generating a target image by processing the initial image according to an objective function;
wherein:
the objective function is constructed based on an acquisition process of the image data,
the objective function includes a fidelity term and a regularization term,
the fidelity term is related to an imaging physical model of the fluorescence microscopy, and
the regularization term is determined using a regularization network.

35. The method of claim 34, wherein:
the regularization network includes a multi-scale convolutional neural network; and
the multi-scale convolutional neural network includes convolutional kernels with different receptive fields.

36. The method of claim 34, wherein the fidelity term is related to a conventional restoration image, and the conventional restoration image is determined based on the imaging physical model of the fluorescence microscopy.

37. The method of claim 34, wherein generating the target image by performing one or more iterations on the initial image according to the objective function, and a current iteration of the one or more iterations includes:
determining a partial derivative of the fidelity term based on the conventional restoration image and an output image of a previous iteration of the current iteration;
determining a partial derivative of the regularization term based on the output image of the previous iteration; and
determining an output image of the current iteration based on the partial derivative of the fidelity term, the partial derivative of the regularization term, and the output image of the previous iteration.

38. The method of claim 37, wherein the determining a partial derivative of the regularization term includes:
determining the conventional restoration image based on the imaging physical model of the fluorescence microscopy; and
determining the partial derivative of the fidelity term based on the conventional restoration image, the output image of the previous iteration and a preset relationship between the partial derivative of the fidelity term, the conventional restoration image, and the output image of the previous iteration;
wherein
the preset relationship is related to a noise of the imaging physical model of the fluorescence microscopy.

39. The method of claim 37, wherein the determining the partial derivative of the regularization term based on the output image of the previous iteration includes:
reversing the regularization network to obtain a reversed regularization network; and
determining the partial derivative of the regularization term based on the reversed regularization network.

40. The method of claim 39, wherein the reversing the regularization network includes:
transforming a convolutional layer of the regularization network into a transpose convolutional layer with a same convolutional kernel;
transforming an activation function of the regularization network into a gradient of the activation function;
transforming a potential function of the regularization network into a gradient of the potential function; and
transforming one or more blocks of the regularization network into one or more transpose blocks.

41. The method of claim 34, wherein the regularization network is obtained according to a training process includes:
obtaining a plurality of reference images with an illumination laser intensity higher than an intensity threshold and an exposure time longer than a time threshold, the plurality of reference images being acquired by the fluorescence microscopy;
obtaining a plurality of sample multi-dimensional images by superimposing one or more noises to the plurality of reference images; and
obtaining the regularization network by training an initial regularization network using the plurality of sample multi-dimensional images as training samples and corresponding reference images as labels, including:
inputting the training samples into the initial regularization network to obtain output images;
adjusting parameters of the initial regularization network based on differences between the output images and the labels.

42. The method of claim 34, wherein the fluorescence microscopy includes at least one of a structured illumination microscopy (SIM), a confocal spinning disk microscopy (CSDM), a wide field microscopy (WFM), a three-dimensional structured illumination microscopy (3D-SIM), or a Fourier light field microscopy (FLFM).

43. The system of claim 31, wherein the regularization network is obtained according to a training process including:
obtaining a plurality of reference images with an illumination laser intensity higher than an intensity threshold and an exposure time longer than a time threshold, the plurality of reference images being acquired by the fluorescence microscopy;
obtaining a plurality of sample multi-dimensional images by superimposing one or more noises to the plurality of reference images; and
obtaining the regularization network by training an initial regularization network using the plurality of sample multi-dimensional images as training samples and corresponding reference images as labels, including:
inputting the training samples into the initial regularization network to obtain output images;
adjusting parameters of the initial regularization network based on differences between the output images and the labels.
